(19) United States
(12) Patent Application Publication
(10) Pub. No.: US 2026/0331136 A1
(43) Pub. Date: Oct. 22, 2026

(54) INCREASING WRITE SPEED OF OPTICAL DATA BY PRE-STRESSING GLASS STORAGE MEDIA

(71) Applicant: Microsoft Technology Licensing, LLC, Redmond, WA (US)

(72) Inventors: Krista Anna Alice PAASONEN, Espoo (FI); Esa Tapani RÄIKKÖNEN, Espoo (FI)

(73) Assignee: Microsoft Technology Licensing, LLC, Redmond, WA (US)

(21) Appl. No.: 19/183,242

(22) Filed: Apr. 18, 2025

(51) Int. Cl. G11B 33/14; G11B 7/00; G11B 7/0037; G11B 7/127; G11B 7/26

(52) U.S. Cl. CPC G11B 7/24; G11B 7/24038; G11B 7/26; G11B 23/0035; G11B 33/1433; G11B 2007/0009

(57) ABSTRACT

Tensile stress in a glass substrate of an optical storage medium is reduced by pre-stressing the substrate in compression to counteract thermally- and inertially-induced tensile stresses experienced during write operations using a pulsed laser. In a first embodiment, a uniform compressive stress distribution is realized in the medium by performing write operations in an enclosure that is positively pressurized by a gas. In a second embodiment using a disc-shaped optical storage medium, compressive forces are directed radially inward using circumferentially-located mechanical engagement members. A third embodiment uses a metal tension strip that is heat-treated to induce tensile hoop stress in the strip. The metal tension strip functions as a circumferential compression band around a disc-shaped optical storage medium. Axially-directed forces can be applied to support the center of the disc in the second and third embodiments to mitigate against buckling from the radially-inward directed forces.

### BACKGROUND

Mass storage of digital data relies on conversion of the data into a persistent, physical perturbation, or state change, within a data-storage medium. Current methods to optically write data using a pulsed laser into storage media made of glass generally provide satisfactory outcomes in realizing low-cost and durable data storage. In write systems using moving media, write speed is constrained by a combination of factors. Inertial stress, combined with thermally-induced stress from the laser, can reach levels that damage the glass, compromising data integrity and reliability of the media. Ensuring that tensile stress remains at safe levels in the glass by limiting laser pulse rate/duration and media rotation speed can restrict overall write speeds.

### SUMMARY

An optical storage medium produced using a glass substrate is pre-stressed in compression to compensate for tensile stress that is imparted to the glass during write operations using a pulsed laser that is sequentially focused at different locations within the interior of the storage medium to form nanostructures, referred to as “voxels,” that optically store data. A portion of the laser irradiation is absorbed by the glass substrate which causes localized and rapid heating of the glass. Accumulated heat in the writing region can result in thermally-induced tensile stress in the glass. In write systems using moving media, inertial stress induced in a spinning (or otherwise subjected to acceleration) glass substrate can further add to the tensile stress.

When either the inertially- or thermally-induced stress, or the combination of stresses, exceeds the yield strength of the glass, the resulting damage to the glass substrate can decrease voxel quality and optical storage medium integrity. The pre-stressing of the optical storage medium in compression partially or completely counteracts the induced tensile stress resulting from the localized heating and/or motion of the optical storage medium during write operations. The pre-stressing advantageously enables write speed to be increased, by reducing the conventional limitations imposed on laser pulse duration and repetition rate and/or media motion speed, in which such conventional those conventionally observed limitations are intended to keep tensile stress below predetermined limits to avoid voxel quality issues and damage to the glass substrate.

In illustrative embodiments, the pre-stressing of the optical storage medium is implemented using a pressure-sealable enclosure containing a stage that is moveable with respect to a write head for the laser. The optical storage medium is placed on the stage and a gas is introduced into the enclosure until at least a predetermined minimum positive pressure is reached. The positively-pressurized gas induces a substantially uniform distribution of compressive stress in the optical storage medium. The stage is configured to impart rotation to a disc-shaped optical storage medium in some embodiments.

In other illustrative embodiments, pre-stressing of an optical storage medium having a disc-shaped body (which may include a central through-hole in some cases) is implemented using a tension strip (e.g., formed from metal) that functions as a circumferential compression band encircling the annular peripheral edge portion of the body. Heat is applied to the metal tension strip, using a furnace or by welding, such that when the optical storage medium cools to ambient temperature, a tensile hoop stress is induced in the metal tension strip. The tensile hoop stress in the metal tension strip provides a substantially uniform radially-inward compressive stress from the edge towards the through-hole throughout the body.

In other illustrative embodiments, a rotatable stage has a circular receiving area to accommodate a disc-shaped optical storage medium which may optionally include a central aperture that locates the medium on the stage with respect to its axis of rotation in some cases. A plurality of radial compression fixtures is positioned circumferentially around the circular receiving area of the stage and operated to apply forces directed radially inward from a peripheral edge of the optical storage medium toward the centrally located aperture. A control system, coupled to the radial compression fixtures, controls the moveable operations of the fixtures to maintain a distribution of inward radial compressive stress within the optical storage medium. In some embodiments, axial compression fixtures, such as a radially-expandable mandrel interfacing with walls of the central aperture, support portions of the optical storage medium around the aperture to mitigate against buckling from the radially-inward forces from the radial compression fixtures.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 shows an illustrative optical storage medium that includes a plurality of voxels arranged in a three-dimensional array;

FIG. 2 shows an illustrative optical data write and read system;

FIG. 3 shows an illustrative optical data write system using a disc-shaped optical storage medium;

FIG. 4 shows an illustrative optical data write system using a rectangularly-shaped optical storage medium;

FIG. 5 shows an illustrative optical data read system;

FIG. 6 shows an exemplary vector representing centrifugal forces that are induced in an optical storage medium from rotation about a central axis;

FIG. 7 shows inertial stresses that are induced in an optical storage medium from rotation about a central axis;

FIG. 8 is an illustrative graph of tensile stress in a rotating disc;

FIG. 9 is a taxonomy of techniques for pre-stressing a glass substrate in an optical storage medium;

FIG. 10 shows a cutaway view of an illustrative pressure-sealed enclosure that provides a pressurized environment in which optical data write operations for an optical storage medium are implemented;

FIG. 11 is a plan view of an illustrative rotating optical storage medium in which centrifugal forces arising in a rotating optical medium are counteracted, wholly or in part, using radially-inward directed forces that are applied at the peripheral edge of the medium;

FIG. 12 is a side view of an illustrative rotating optical storage medium showing axial forces provided around a central aperture to mitigate against buckling of the optical storage medium by radially-inward directed forces that are applied at the peripheral edge of the medium;

FIG. 13 shows illustrative engagement members that are utilized to apply radial and axial forces to the optical storage medium during optical data write operations;

FIG. 14 shows an alternative illustrative configuration for engagement members;

FIG. 15 shows an illustrative arrangement of radial compression fixtures that each comprise an engagement member and an actuator;

FIG. 16 shows an illustrative arrangement of radial compression fixtures that each comprise an engagement member and an actuator that are coupled by a linkage;

FIGS. 17 and 18 show an illustrative arrangement of radial compression fixtures that utilize mechanical actuation;

FIGS. 19, 20, and 21 show an illustrative example of a radially expanding mandrel that applies forces to an optical storage medium;

FIGS. 22, 23, and 24 show an illustrative example of a radially expanding mandrel that applies radial and axial forces to an optical storage medium;

FIGS. 25 and 26 show an illustrative example of a mechanical fastener that provides axial forces to an optical storage medium;

FIG. 27 shows a disassembled view of a disc-shaped glass substrate body of an illustrative optical storage medium and a tension strip that is fabricated, for example, from metal;

FIG. 28 shows an assembled view of a disc-shaped glass substrate body of an illustrative optical storage medium and a metal tension strip;

FIG. 29 shows an assembled view of a disc-shaped glass substrate body of an illustrative optical storage medium and a metal tension strip after welding operations are performed to induce tensile hoop stress in the metal tension strip;

FIG. 30 shows an illustrative furnace used to induce tensile hoop stress in a metal tension strip;

FIGS. 31 and 32 are flowcharts of illustrative methods that are facilitated using the present principles; and

FIG. 33 is a simplified block diagram of an illustrative computing device that may be used, at least in part, to implement aspects of the present principles.

Like reference numerals indicate like elements in the drawings. Elements shown in the drawing are not drawn to scale.

### DETAILED DESCRIPTION

Demand for archival storage for high-value, long-lived data continues to grow exponentially. Cloud archival storage providers utilize statistical multiplexing of many customers' workloads onto a shared storage platform to offer the lowest storage cost. Today, in all large-scale cloud providers, the most cost-effective media is magnetic, usually combining hard disk drives (HDDs) and tape. All magnetic media have limited lifetimes, and the data on it degrades over time, thus the data needs to be migrated. In particular, HDDs have about a 5-year lifetime and tape has about a 10-year lifetime. Since bit rot occurs in both magnetic media types over time, storage systems use scrubbing to guarantee data integrity. In addition, both have significant media costs, requiring garbage collection and defragmentation over time. As a result, while it may be intuitive to assume that data storage costs are a function of the customer access rates, for most archival workloads, the background management accesses associated with the refresh cycle, data integrity checking, and garbage collection dominate user accesses. Hence, these background management accesses also dominate the costs associated with storing data. Since most archival data is rarely accessed, the environmental and financial costs of storing archival data on magnetic media increase over time.

Archival storage systems designed using glass storage media are providing a clean-slate approach to service modern cloud archival workloads sustainably, reliably, and efficiently. Using glass provides extremely low-cost Write-Once-Read-Many (WORM) media with no bit rot over more than 1000 years. This latter property means that the media removes the need for integrity checking, minimizing energy usage over time. Since the media is low-cost, it also removes the need to perform active garbage collection. Finally, the design of the storage system around glass media removes the need for the refresh cycle, allowing data to be left in situ, and dramatically reducing the carbon footprint of long-lived data.

A voxel is a light-scattering nanostructure located in a transparent optical storage medium. In an illustrative embodiment, voxels exhibit optical properties, including birefringence, that are different from the surrounding glass. Using femtosecond laser pulses, a plurality of voxels is written into an interior volume of a durable low-cost glass optical storage medium. Voxels may be organized as two-dimensional (2D) arrays in an xy plane of the medium in multiple layers along a z axis to store symbols for differentially encoded data. Each voxel is written using multiple pulses to achieve a homogeneous birefringence at the vicinity of the laser focus.

Voxels have form birefringence in which the voxel exhibits optical properties that are different from the surrounding glass. Two optical dimensions, provided by birefringence properties including retardance and polarization angle change, in combination with three spatial dimensions, enable multiple bits to be encoded per voxel (e.g., 3 to 4 bits of data representing multiple symbols). When a polarized laser beam from a lighting system in a read system propagates in the optical storage medium and interacts with a voxel, a nanometer-scale shift in components of its electrical field occurs (in which the range of shift corresponds to the voxel's retardance) along with a change in polarization angle. In alternative implementations of the present principles, phase voxels may be formed in a given optical storage medium, using suitable write techniques, to supplement or replace birefringent voxels. Phase voxels can be imaged in appropriately-configured read systems in which the signals from the voxels are encoded with phase-contrast information.

In an illustrative example, polarization microscopy is used to image voxels of interest in an xy plane in the optical storage medium. The optical field modified by the voxels is measured by light-sensitive image sensors of a polarimetric camera system. A decoder is utilized to decode and extract the encoded symbols from the image data captured by the camera system. Additional post-processing, including machine learning, is utilized in some implementations to provide increased accuracy in converting the image data into digital data.

For data storage in glass to be a more widespread solution, the write process for data needs to be accurate and reliable while being performed as fast as possible with consistent high quality. The write process directs the focused femtosecond laser pulses to each required voxel position by scanning or translating the beam of laser pulses along a write path within the interior volume of the glass substrate. The sub-surface exposure of the glass to the laser pulses induces a permanent and localized modification to the glass structure to form voxels with the desired birefringence properties as laser-induced nanostructures. The rate of voxel formation is referred to as the write speed. The laser pulses are configured with characteristics such as pulse energy, duration, repetition rate, and wavelength, in order to deliver an amount of optical energy to a selected location along the write path within the substrate volume. For a given pulse repetition rate, the scan speed is adjusted to distribute the voxels evenly along the scan direction, accordingly to a chosen linear pulse density, in units of number of pulses per distance of path length. The total amount of energy delivered to the material then depends on the energy per pulse and the pulse repetition rate.

It can be technically challenging to increase write speeds over current levels because tensile stresses are typically induced in the glass substrate during write operations attendant with optical data storage (as used hereinafter, write operations refer to the processes used to optical write data to the optical storage medium in the form of voxels using a pulsed laser along a write path). Increasing the pulse density can accumulate heat that causes heat-induced stress to exceed a target level. Moving the substrate faster relative to the write head can cause inertial stress to exceed a target level. Controlling stress in the glass substrate of the optical storage medium after exposure to the laser pulses is important to ensure that write and read operations provide data storage and retrieval goals with a desired level of reliability.

The setting of a target for a maximum operational stress level for glass substrates during write operations typically accounts for statistical failures from excessive tensile stress, based on various combinations of material testing, probabilistic modeling, and component-specific scaling. In the illustrative embodiments covered in the discussion that follows, a maximum tensile stress allowed for the glass substrate is set at 5 MPa for the combined thermally-induced and inertially-induced stresses. This target maximum operational tensile stress level is below mean failure stresses observed in material testing for typical glass substrates, but appropriately balances statistical reliability against constraints imposed by the write processes described herein. It is noted that this particular target maximum operational tensile stress level is illustrative. It may be appreciated that other values targeted for a maximum allowable tensile stress could be specified for other applications in which pre-stressing of a glass substrate is utilized. For example, parameters dealing with glass properties, statistically-based reliability metrics, and write processes may be different from those disclosed with the present illustrative embodiments. In such circumstances, a different target maximum operational tensile stress level may be appropriately utilized to meet applicable goals and requirements

In accordance with the present principles, tensile stress in the glass substrate of an optical storage medium is reduced by pre-stressing the glass substrate in compression to partially or wholly counteract the thermally-induced and inertially-induced tensile stresses experienced during write operations. In a first embodiment, a substantially uniform compressive stress distribution is realized throughout the optical storage medium by performing write operations in an enclosure that is positively pressurized by a gas. A second embodiment uses a disc-shaped optical storage medium which may optionally include a central through-hole or aperture that facilitates alignment on a rotating stage. Compressive forces are directed radially inward using circumferentially-located mechanical engagement members that interface with the perimeter of the medium and direct force from actuators such as piezoelectric, mechanical, and electromechanical actuators. A third embodiment uses a tension strip that may be formed, for example, from metal and which is heat-treated to induce tensile hoop stress in the strip. The metal tension strip functions as a circumferential compression band around a disc-shaped optical storage medium. Axially-directed forces can be applied to support the center of the disc in the second and third embodiments to mitigate against buckling from the radially-inward directed forces. A combination of directional forces and a positively-pressurized write environment may also be utilized in some embodiments.

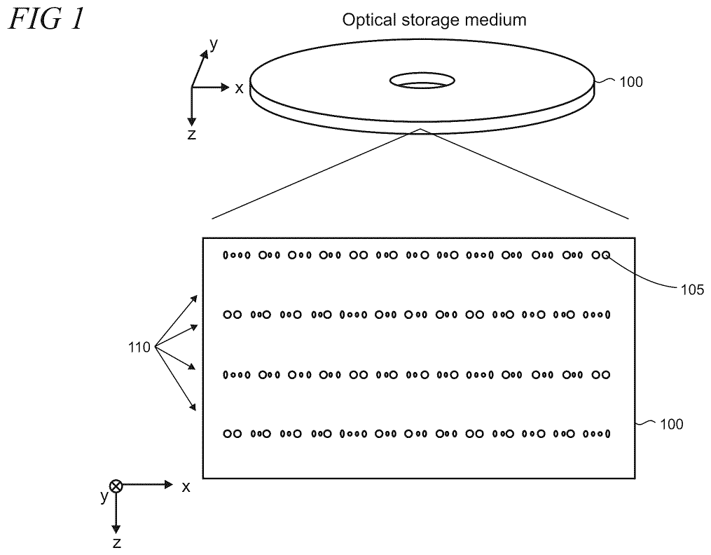

Turning now to the drawings, FIG. 1 shows an illustrative optical storage medium 100 that includes a plurality of voxels, representatively indicated by reference numeral 105, that are arranged in a three-dimensional array. It is noted that the drawings are not drawn to scale and are presented in a schematic manner for the purpose of clearly illustrating the inventive principles. As such, no dimensional information or proportional relationships between depicted elements should be inferred from these schematic representations.

The substrate for the optical storage medium is substantially transparent to the wavelengths used during reading and writing, and typically takes the form of bulk glass, for example, including but not being limited to one of borosilicate, soda-lime, alumino-silica, or fused silica (i.e., quartz) glasses. It may be appreciated that economic and engineering considerations, among other considerations, will typically affect the choice of glass type utilized in a given implementation of the present principles. The substrate may be formed using a relatively thin optical layer that is coupled to a mechanically stable supporting layer in some applications. Glass is typically an ideal media for archival storage because it has three suitable properties: (i) it is low-cost; (ii) it is chemically inert and therefore durable and resilient to the environment (e.g. temperature, moisture, and electromagnetic interference); and (iii) the structures used to store data have lifetimes of over a thousand years.

The voxels 105 are light-scattering nanostructures that are embedded in the optical storage medium 100. The voxels are typically written in layers 110 to encode digital data that is read optically, as described below. Data is stored in the glass by using laser pulses to make permanent physical modifications within the volume of the medium which are not susceptible to bit rot or corruption. Therefore, glass becomes both a sustainable cost-effective WORM medium.

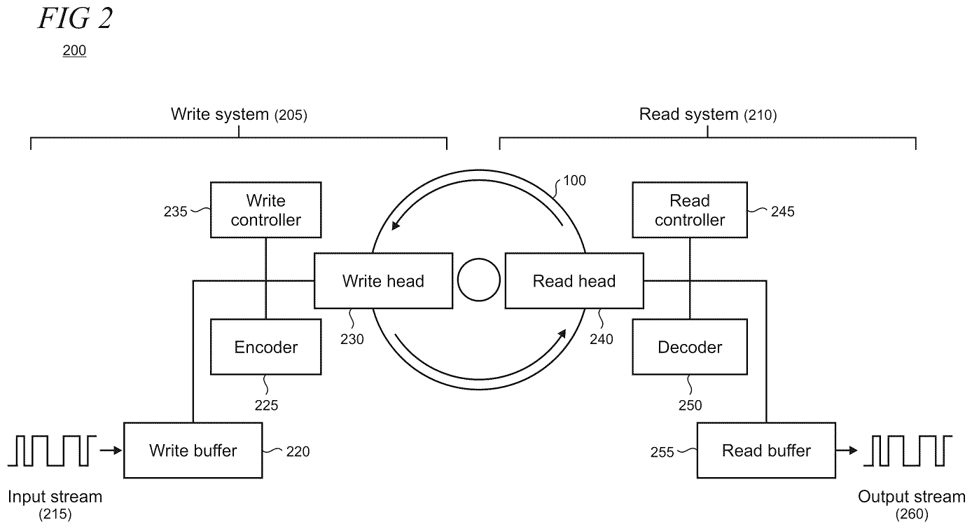

FIG. 2 shows an illustrative optical data write and read architecture 200 that interfaces with the optical storage medium 100 embodied as a rotating disc. It is emphasized that while the constituent write system 205 and read system 210 are shown in the same drawing to facilitate discussion of the present principles, they are typically operated independently and non-simultaneously. Moreover, the write architecture may be omitted from devices that only read the medium. For example, in typical mass storage scenarios, data is written to a plurality of optical storage media for archiving in a storage library. At some later time, one or more optical storage media are retrieved from storage and read using the processes described herein to access the stored data. Mass storage providers have the flexibility to separately support and provision the write, storage, and read processes. Providers can apply and scale resources as needed to meet variability of workloads across datacenters so that write, storage, and read capacities are efficiently utilized without excess capacity being stranded and/or insufficient capacity causing bottlenecks and delays.

An input data stream 215 to be written to the optical storage medium 100 is buffered in a buffer 220 in the write system 205. An encoder 225 parses the data in the buffer to provide suitable signals to a write head 230 under control of a write controller 235 according to a desired encoding for the voxels. A read head 240 in the read system 210 reads the data that has been written to the optical storage medium according to parameters provided by a read controller 245. The read data is passed to a decoder 250 which decodes and outputs the data to a read buffer 255, from which an output stream 260 is made available.

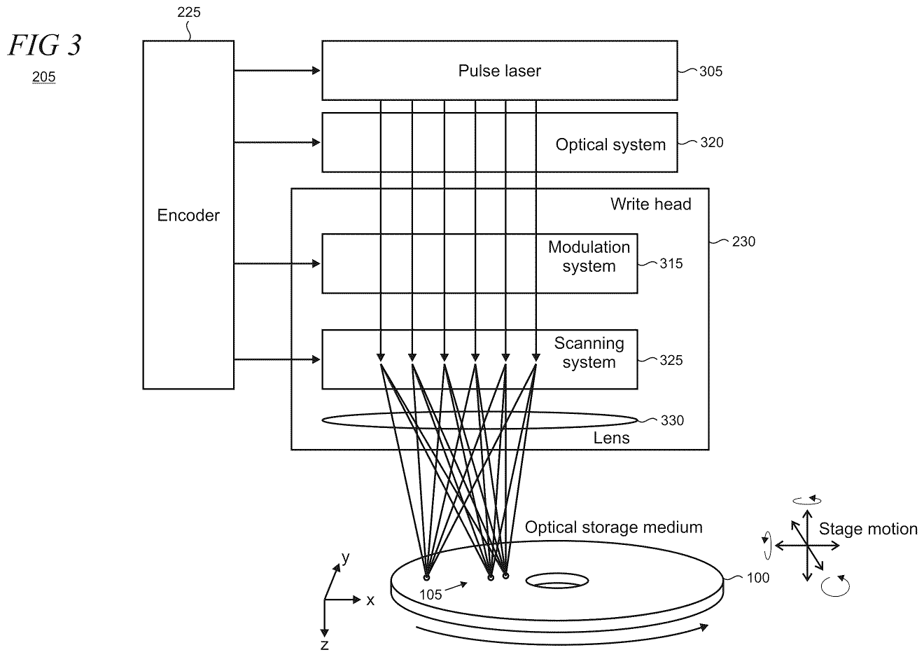

As shown in FIG. 3, the permanent modifications to change the physical structure of the glass forming the voxels 105 are created using femtosecond-scale (~10⁻¹⁵ seconds) high power pulses from an ultrashort pulse laser 305 in the write system 205. To create a voxel, pulses are focused at varying depths into the glass of the optical storage medium 100. A single voxel can typically encode multiple bits by modulating the polarization of the laser beam and the pulse energy during voxel creation using a modulation system 315 in the write head 230 based on instructions from the encoder 225. In some write systems, the pulse laser 305 is optically coupled to the modulation system via an optical system 320. The optical system may include beam splitting and/or beam steering optics. A scanning system 325 and/or a lens 330 are provided, in this illustrative example, to control points of focus for laser pulses within the interior volume of the optical storage medium along a write path. The scanning system is implementable using, for example and not by way of limitation, MEMS (micro electromechanical system) scanners with moveable mirrors, polygon scanners with rotating mirrors, galvanometer scanners with rotating mirrors, piezo scanners, resonant optical scanners, and other suitable scanner types and devices.-electro-mechanical systems (MEMS). The lens 330 is implementable to have variable depth of focus.

It is noted that the location and packaging of the components in the write system can vary by implementation and thus be different from what is shown in FIG. 3. For example, the write head 230 may be configured to incorporate the pulse laser 305 and/or the optical system 320. Similarly, one or more of the modulation system 315, scanning system 325, or lens 330 can be packaged externally from the write head.

The voxels 105 are typically written in a manner to extend in three dimensions within the interior volume provided by the optical storage medium 100. For example, voxels may be located side-by-side using the write system in 2D arrays across the xy plane, and many hundreds of layers along the z dimension can typically be utilized.

The optical storage medium 100 and write head 230 are typically configured to enable relative motion between them, typically using multiple degrees-of-freedom of motion. For example, the optical storage medium is located on a rotating stage (not shown) that may also translate in the xy plane and/or move up and down along the z axis, and/or provide rotation about one or more axes. Alternatively, the stage may be fixedly located, while still providing for rotation of the optical storage medium, and the write head configured to be moveable with suitable degrees of freedom of motion with respect to the fixed stage. It may be appreciated that the scanning system 325 and lens 330 may be configured and operated in a manner that depends on an extent to which relative motion is enabled between the write head and the optical storage medium.

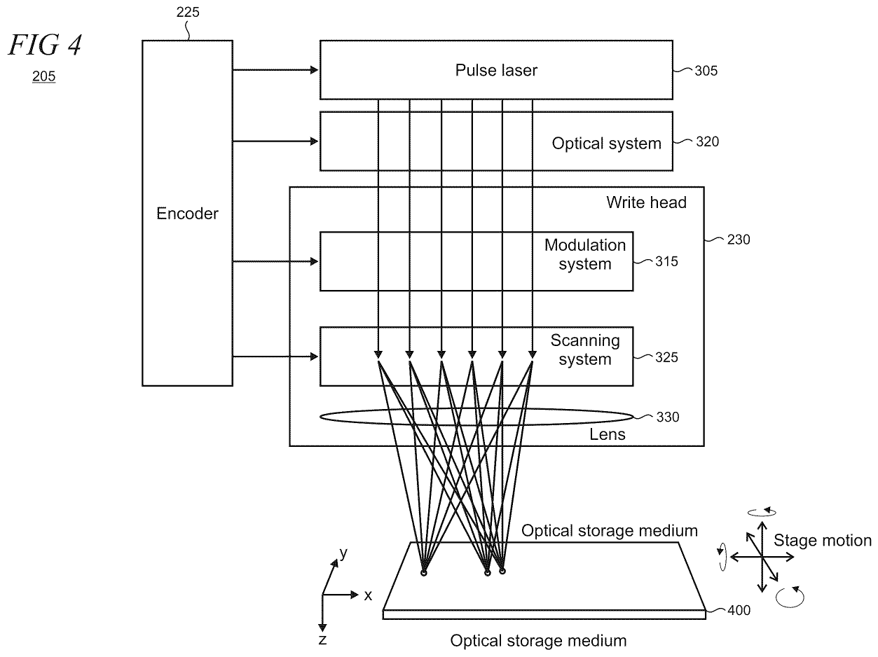

FIG. 4 shows an illustrative alternative form factor for an optical storage medium 400. In this illustrative example, the form factor is rectangular and is arranged on a stage (not shown) that facilitates movement with suitable degrees of freedom of motion to control the relative positioning between the optical storage medium and the write head 230. Voxels may be written at different locations in the xy plane of the interior volume of the medium 400 while the pulse laser 305 is focused at varying depths by the lens 330 to produce layers of voxels along the z axis.

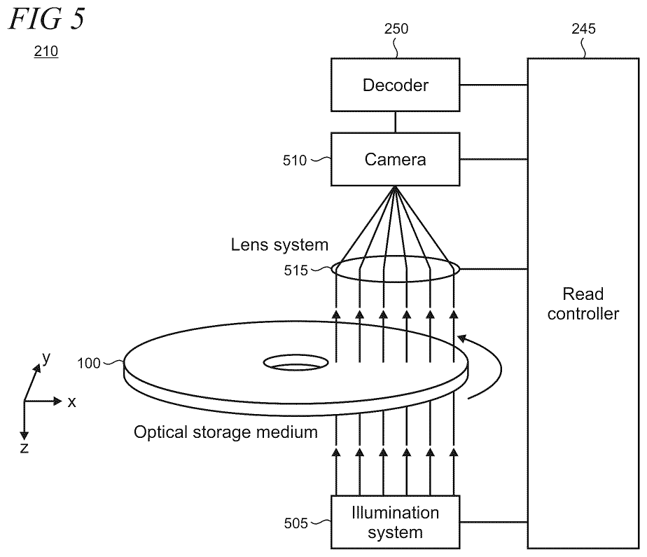

FIG. 5 shows aspects of the read system 210. The system includes a polarized illumination system 505 and a camera 510. The illumination system may comprise a low-power diode laser or other polarized light source. The read controller 245 is operatively coupled to the illumination system and configured to control the emission of the illumination system.

The camera 510 is implementable, for example, using a high resolution/high frame rate complementary metal oxide semiconductor (CMOS) or other suitable photodetector or photodiode array. The camera is a polarimetric camera configured to capture information about the polarization of light. The camera is further configured to image light from the illumination source after the light has interacted with the voxels in the optical storage medium 100. Although FIG. 5 illustratively shows transmission of illumination rays through the optical storage medium and onto the camera, the rays may, in alternative configurations, reach the camera by reflection from the medium.

Each image frame acquired by the camera 510 may include a plurality of component images captured simultaneously or in rapid succession. The camera may resolve, in corresponding pixel arrays of the component images, localized intensity in different polarization planes. Accordingly, the camera may include switchable or tunable polarization control in the form of liquid crystal retarder cells, for example. Multiple images of each target portion of the optical storage medium are acquired in sequence by the camera as the illumination source provides rays using different polarization angles. This enables capture of the birefringent properties of the voxels of the imaged target portion.

In implementations in which data is read from a plurality of layers in the optical storage medium 100, the read system 210 includes an adjustable lens system 515. The adjustable lens system collects light rays diffracted from a selected depth layer of the optical storage medium, while rejecting other light rays. In alternative implementations, lens-less imaging based on interferometry may be employed.

The decoder 250 is configured to receive the component images from the camera 510 and to implement image processing necessary to retrieve the data stored in the optical storage medium 100. Such data may be decoded according to a machine-learned method and/or a canonical method in which an observable physical property is connected through one or more intermediates to the data read from the optical storage medium.

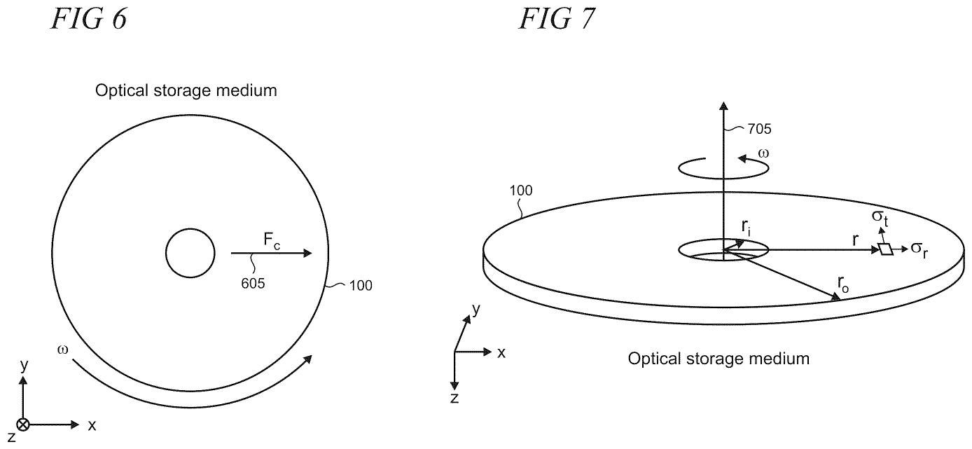

In implementations in which the optical storage medium 100 is rotated during write operations about a central axis at a rotation speed ω, a centrifugal force F_{C} is induced in a radial direction extending from the central axis outwards towards the perimeter of the medium, as shown in FIG. 6. Although a single F_{C} vector 605 is shown in the drawing for sake of clarity in exposition, it may be appreciated that the vector 605 is representative of centrifugal forces that affect all locations within the optical storage medium.

The centrifugal forces from the rotation of the optical storage medium 100 give rise to inertial stresses, as shown in FIG. 7. At a given location in the medium having a radius r from the central axis 705, the inertial stress includes a radial component, σᵣ, and a tangential component, σₜ (referred to as “hoop stress”). The radial stress σᵣ in a rotating disc having a constant thickness with a central through-hole is given by:

$${σ}_{r} = {ρω}^{2} [ \frac{3 + v}{8} ( {r}_{i}^{2} + {r}_{o}^{2} - \frac{{r}_{i}^{2} {r}_{o}^{2}}{{r}^{2}} - {r}^{2} ) ]$$

and the tangential stress σₜ is given by:

$${σ}_{t} = {ρω}^{2} [ \frac{3 + v}{8} ( {r}_{i}^{2} + {r}_{o}^{2} + \frac{{r}_{i}^{2} {r}_{o}^{2}}{{r}^{2}} ) - \frac{( 1 + 3 v )}{( 3 + v )} {r}^{2} ]$$

where r₁ is the radius of the through-hole (m), rₒ is the radius of the optical storage medium (m), ρ is the material density (kg/m³), ω is angular velocity (rad/s), and v is Poisson's ratio. See Budynas, Richard G., and J. Keith Nisbett. Shigley's Mechanical Engineering Design. 10th ed. New York: McGraw-Hill, 2015, page 129.

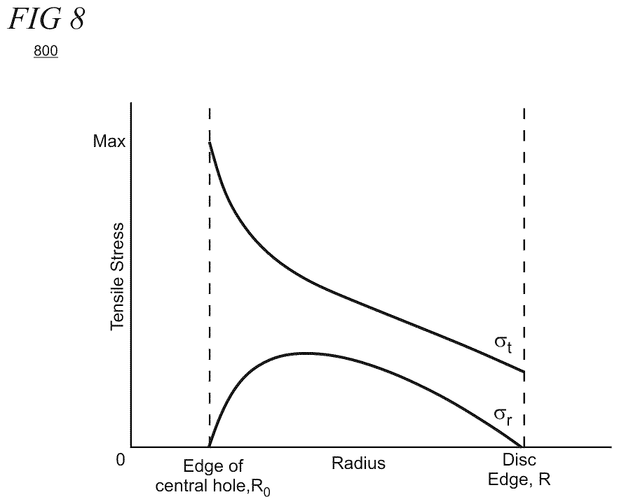

As shown in the tensile stress graph 800 in FIG. 8, the radial stress σᵣ is zero at boundaries of the optical storage medium at the edge of the central through-hole and at the edge of the medium. The tangential stress σₜ has a maximum value at the edge of the central through-hole and a minimum value at the edge of the medium. As shown in the equations above, both stress components increase with the square of the speed of rotation of the optical storage medium, ω. In implementations in which the optical storage medium 100 is translated (e.g., with or without rotation), it may be appreciated that some inertial stresses are induced as the medium is accelerated from a rest position into motion. Such translation-induced stresses are transitory because the acceleration goes to zero once the medium reaches a constant linear (i.e., straight-line) velocity. In addition, as translation-induced inertial stresses vary linearly with acceleration, they are generally small compared to stresses from rotation which increase quadratically with rotation speed.

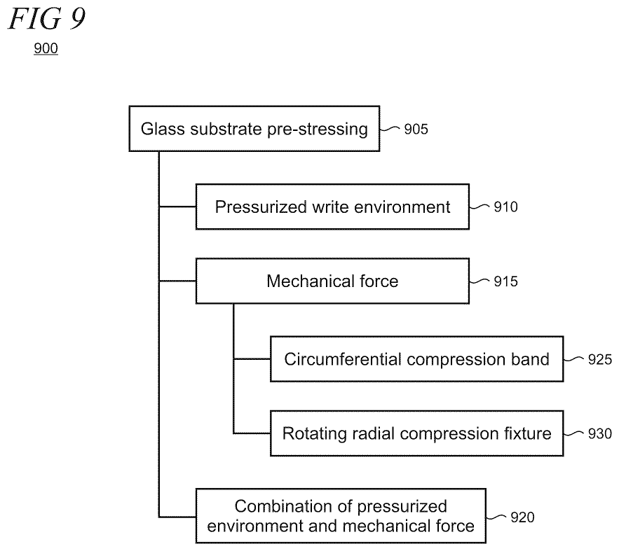

The thermal and inertial tensile stresses arising in the optical storage medium are counteracted by pre-stressing the glass substrate in compression in accordance with the present principles. As shown in the taxonomy 900 in FIG. 9, glass substrate pre-stressing techniques 905 include a use of a pressurized write environment 910 and the application of mechanical force 915. In some implementations, a combination 920 of a pressurized write environment and mechanical forces is utilizable. Application of mechanical force is implemented using either a circumferential compression band 925 that is constructed, in an illustrative embodiment, from a metal tension strip subjected to heating and cooling to induce tensile hoop stress in the band, or an arrangement comprising rotating radial compression fixtures 930. The pre-stressing techniques may be statically implemented, for example, in advance of commencement of the write operations. Alternatively, pre-stressing techniques, such as those involving a pressurized write environment and mechanical forces, can be dynamically implemented to be contemporaneously applied with the write operations.

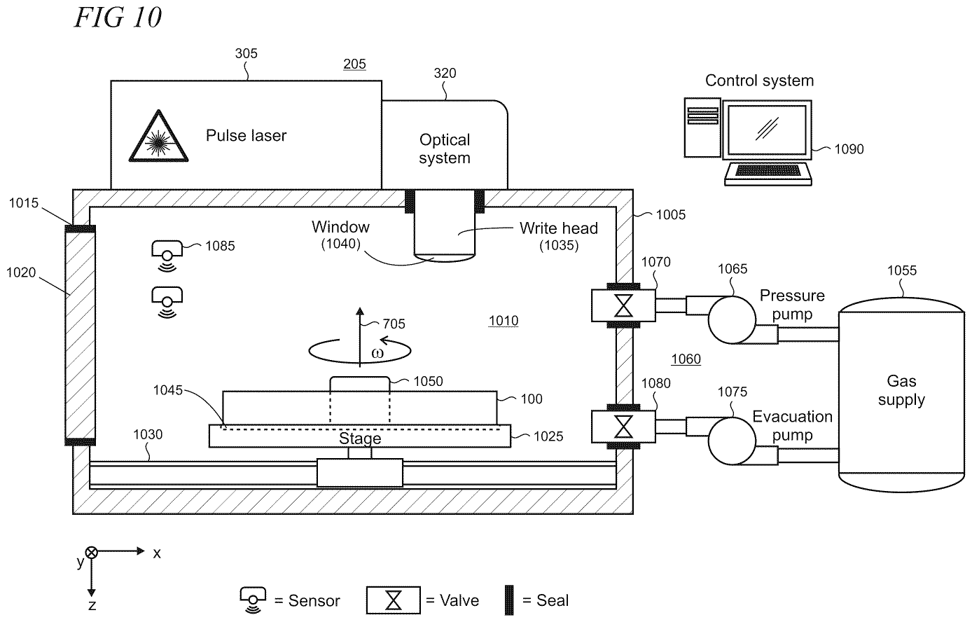

FIG. 10 shows a cutaway view of an illustrative pressure-sealed enclosure 1005 that provides a pressurized environment 1010 in which optical data write operations for the optical storage medium 100 are implemented. Any openings such as doors and access points for external systems and equipment are protected by seals or other suitable devices and fittings to maintain a positive pressure differential with the ambient environment surrounding the enclosure. A representative seal 1015 is shown around a door 1020.

The enclosure includes a moveable stage 1025. In this illustrative example, the stage operates on a track 1030 that enables translation with respect to a write head 1035 that is partially exposed to the pressurized environment through a pressure-tight window 1040. In this illustrative example, the stage imparts rotation to the disc-shaped optical storage medium 100 which sits in a receiving area 1045 on the stage. The optical storage medium includes a centrally-located aperture or though-hole to facilitate axial location on a spindle 1050. The stage and optical storage medium revolve about the central axis of rotation 705 at an angular rotation of @ during write operations. In an alternative configuration, the stage moves in translation only, for example, when the optical storage medium has a rectangular form factor (e.g., as shown in FIG. 4). In another alternative configuration, the stage imparts rotation to the optical storage medium while write operations are performed with the location of the stage in the enclosure being static relative to the write head. In another alternative configuration, the write head is configured for motion relative to the stage (which may be fixed or moveable with respect to the write head and/or the enclosure).

Gas from a supply 1055 is introduced into the enclosure 1005 to a predetermined positive pressure, for example 5 MPa, using pumping system 1060 that comprises, for example, a pressure pump 1065 (which may comprise a multi-stage pump), an entrance valve 1070, an evacuation pump 1075, and an exit valve 1080. The gas may comprise an inert gas, for example, nitrogen, carbon dioxide, helium, and the like, or some combination of inert gases. Reactive gases, including, for example, air, may be solely utilized in some implementations, or in combination with inert gases in other implementations. However, air often contains contaminants such as oil, water, and solid particles which may be undesirable to introduce into the write environment. Accordingly, when air is utilized, it may be treated or processed to remove contaminants. A liquid-pressurized environment may also be utilized in some alternative embodiments of the present principles. In other alternative embodiments, high-pressure liquid jet streams are uniformly delivered around the perimeter edge of the optical storage medium using a suitable liquid jetting system. The particular environment and choice of pressurization media can be selected to meet applicable requirements which may include various environment factors and media material properties such as refractive index.

One or more sensors 1085 such as pressure sensors, temperature sensors, etc., are located within the enclosure. Suitable sensors (not shown) may also be utilized with the pumping system and gas supply in some implementations. Irradiation from the pulse laser 305 is guided by the optical system 320 and write head 1035 impinges the optical storage medium 100 to form voxels in write operations under positive pressure. The positive pressure, which is illustratively set at 5 MPa in this example, thus fully compensates for the maximum allowed tensile stress that would be observed in the glass substrate from thermally-induced and inertially-induced stresses using conventional write methods in which the pre-stressing of the glass is not utilized. It may be appreciated that other levels of positive pressure may be alternatively utilized in some applications. For example, if the thermal and inertial stresses produce a maximum tensile stress of X MPa in the optical storage medium during write operations without the application of external pressure, then application of a positive pressure of P_ext MPa functions as an external DC bias to the internal stress field. Accordingly, the maximum tensile stress in the optical storage medium is (X-P_ext) MPa with application of external pressure. It may be appreciated that maximum tensile stress in the optical storage medium arising from write operations can be fully or partially compensated by the positive pressure environment depending on the value of P_ext utilized in the positive pressure environment in any given implementation.

One or more of the pumping system 1060, gas supply 1055, sensors (e.g., sensors 1085, pumping system sensors, and gas supply sensors), stage 1025, and write system 205 are coupled to a control system 1090 using appropriate communication interfaces and/or networks (not shown) to provide for centralized control over write operations of voxels into the rotating optical storage medium 100 in the pressurized write environment supported in the enclosure 1005. For example, the control system is configurable to control the write system, in synchronization with the moveable stage (i.e., translation and rotation), to enable voxels to be formed along the desired write path. The control system may also maintain the pressurization of the gas within the enclosure during write operations and then lower the pressure and evacuate the gas prior to the optical storage medium being removed from the enclosure after the write operations are concluded. In addition, in illustrative implementations, the control system may utilize signals representing the pressure in the enclosure monitored by the sensors 1085 as inputs utilized for controlling various aspects of the write operations. For example, the control system is configurable to control write parameters for the laser (e.g., write speed, pulse energy, duration, repetition rate, or wavelength), motion of the stage (e.g., rotation and/or translation), and pressure level in the enclosure resulting from operations of the pumping system and/or gas supply. The control system can establish and dynamically maintain a desired pressure in the enclosure throughout the write processes if and when operating conditions change, for example, through normal variations in operations, or from sub-optimal operations of one or more components due to failures or other causes. For example, if the speed of rotation varies during write operations, the control system can send control signals to cause the pumping system and/or gas supply to adjust the pressure up or down, as appropriate, to compensate for the varying inertially-induced stress in the medium. Similarly, if the write parameters change during the write operations, the control system can send control signals to vary the pressure, as appropriate, to compensate for the varying thermally-induced stress in the medium. Conversely, if the pressure in the enclosure varies up or down, the control system can adjust the write parameters and/or stage motion to accommodate such pressure variations to ensure that the target maximum tensile stress in the optical storage medium is not exceeded.

The positively-pressurized write environment inside the enclosure 1005 provides a substantially uniform distribution of compressive stress throughout the optical storage medium 100, at least to a first approximation, due to pressure being uniformly applied to all surfaces of the medium. However, it may be appreciated that heterogeneities in the glass substrate and geometric effects and loading conditions, among other factors, typically disrupt the realization of an ideal uniform stress distribution within the optical storage medium.

In embodiments in which pre-stressing is implemented using mechanical forces, the forces are not applied uniformly on all surfaces of the optical storage medium 100. For example, as illustratively shown in FIG. 11, compressive forces,-F_{C} (where the sign convention in this disclosure uses (−) for compressive forces and (+) for tensile forces), are applied circumferentially along the peripheral edge of the optical storage medium in a radially-inward direction towards the central axis to counteract the centrifugal forces F_{C} induced in the optical storage medium by its rotation during write operations. As in the previous drawing in FIG. 6, a single F_{C} vector 605 is shown in FIG. 11 as being representative of centrifugal forces throughout the optical storage medium. A compressive-F_{C} vector 1105 is representative of compressive forces that are applied at multiple locations around the perimeter of the optical storage medium that counteract the centrifugal forces F_{C} induced in the optical storage medium when rotating at a steady-state. As the centrifugal forces F_{C} increase with increased speed of rotation, the compressive forces-F_{C} need to be increased proportionally to counteract them.

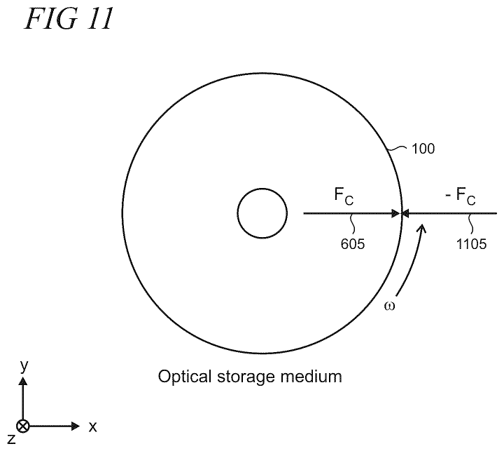

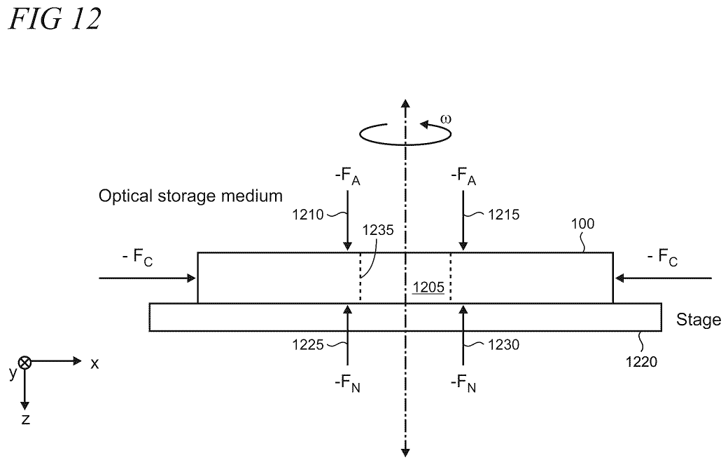

In some embodiments, as illustratively shown in FIG. 12, axially directed forces are applied to the optical storage medium to minimize or prevent buckling or distortion of the glass substrate from application of the radially-inward directed compressive forces. The axially directed forces are generally applied near portions of the optical storage medium around the central aperture or through-hole 1205. For example, vectors 1210 and 1215 represent compressive axial forces-F_{A} applied downwards (i.e., in the z direction) near the edge of the through-hole. It may be appreciated that the stage 1220 exerts opposing normal forces,-F_{N}, as representatively shown by vectors 1225 and 1230. Forces can be alternatively or additionally applied to the side walls 1235 of the through-hole.

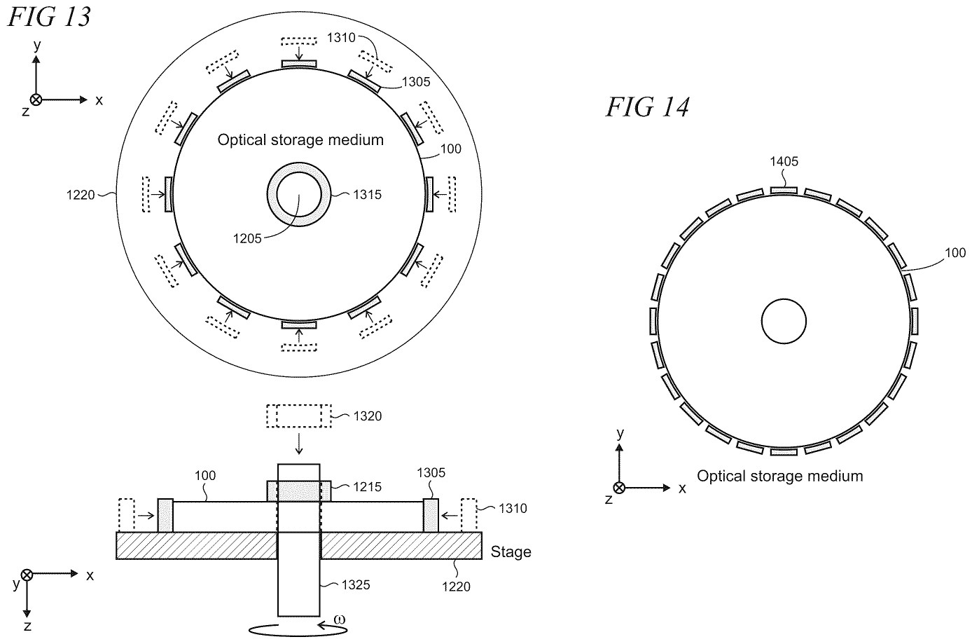

FIG. 13 shows illustrative mechanical engagement members that are part of fixtures utilized to apply radial and axial forces to the optical storage medium 100 during write operations. Multiple radial engagement members, representatively indicated by reference numeral 1305, are circumferentially located on the stage 1220 around the perimeter of the optical storage medium. The radial engagement members move radially inward from unengaged positions, representatively indicated by the dashed line 1310, to engaged positions to interface with vertical edges of the optical storage medium about its perimeter. It may be appreciated that the centrifugal forces arising from rotation of the stage also affect the 1220 also affect the radial engagement members. Thus, the compressive forces-F_{C} discussed above with reference to FIG. 11 are net forces applied to the optical storage medium from the fixtures after taking the effects of rotational inertia of the radial engagement members into account.

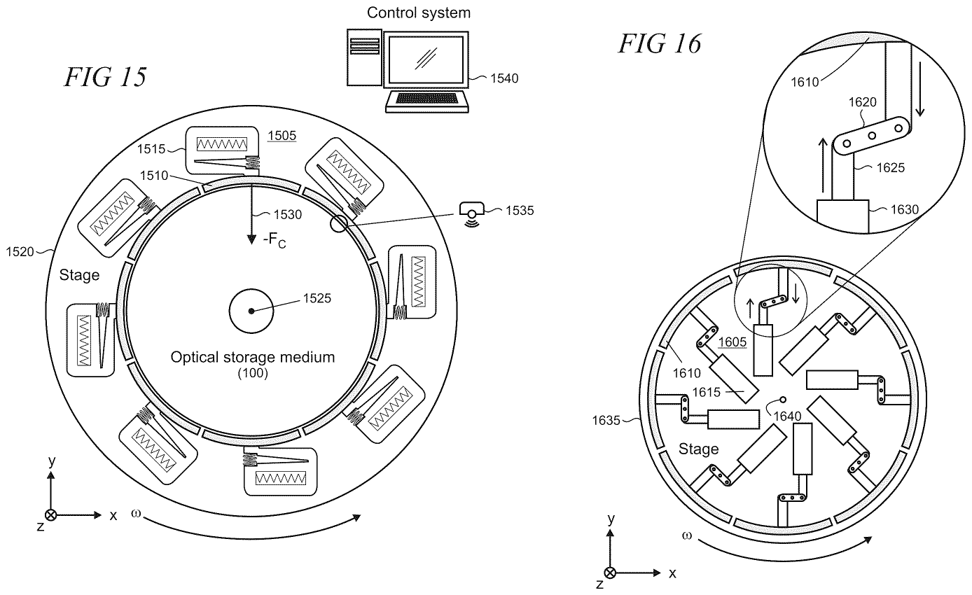

The radial engagement members apply compressive forces on the optical storage medium that are directed radially inward from the perimeter towards the central axis. The forces are imparted by the operations of actuators that may vary by type and include, for example, piezoelectric actuators, hydraulic actuators, pneumatic actuators, magnetic actuators, electric actuators, electromechanical actuators, mechanical actuators, shape memory alloy (SMA) actuators, or actuators that combine different types. Some exemplary actuator and radial engagement member embodiments are described below with reference to FIGS. 15-18.

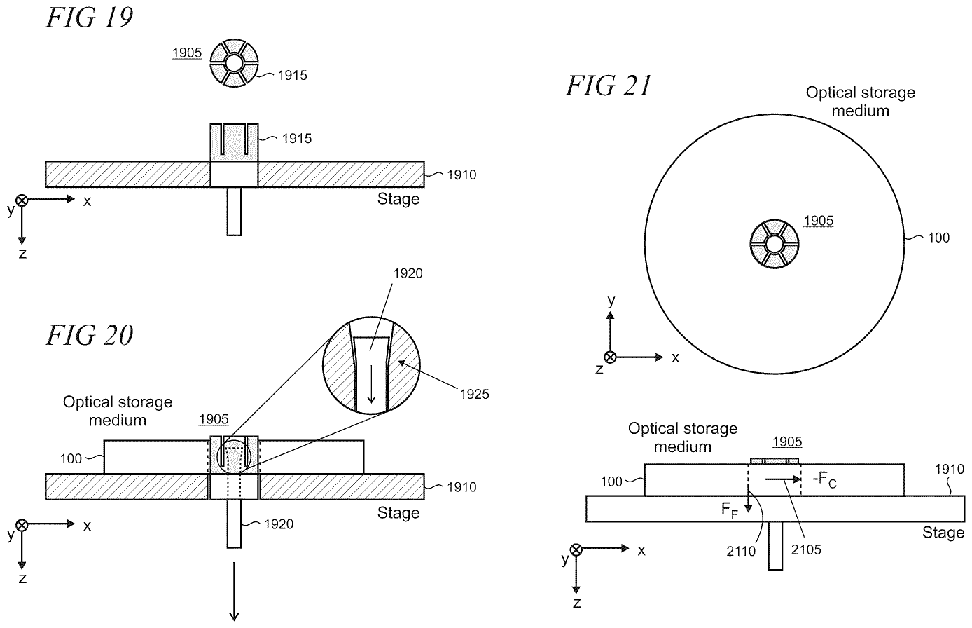

An axial engagement member 1315 provides axial force directed downwards around the edges of the central through-hole 1205 in the optical storage medium 100 to mitigate against buckling in the medium caused by the radially-inward directed forces from the radial engagement members. In this illustrative example, the axial engagement member slides from an unengaged position 1320 along a central spindle 1325 that aligns the optical storage medium with the stage 1220 using the through-hole. The axial forces are imparted by the operations of suitable actuators which may include the types noted above. Some exemplary actuator and axial engagement member embodiments are described below with reference to FIGS. 19-26.

The number and configuration of radial engagement members can vary by implementation. In general, a larger number of radial engagement members can be expected to provide more uniform compressive forces that are directed radially inward from the perimeter of the optical storage medium 100. This occurs because the number of discrete points of force and contact increases as more radial engagement members are provided. For example, in an arrangement shown in FIG. 14, 24 radial engagement members, representatively indicated by reference numeral 1405, are utilized (i.e., twice the number utilized in the arrangement shown in FIG. 13) and the spaces between adjacent members are minimized. It may be appreciated that the particular number and configuration of radial engagement members can vary by application. The uniformity of compressive forces will typically be balanced against the cost and complexity associated with arrangements of radial engagement members with a larger number of members.

FIG. 15 shows an illustrative arrangement of radial compression fixtures in which a representative fixture is indicated by reference numeral 1505. Each of the radial compression fixtures respectively comprises a mechanical engagement member 1510 and an actuator 1515. The engagement members comprise radial engagement members of which eight are utilized in this illustrative example, with minimal spacing between adjacent members. The radial compression fixtures are located outboard of the optical storage medium 100 around its perimeter on the stage 1520 and rotate about the central axis 1525 of the stage along with the optical storage medium.

In this illustrative example, the actuator 1515 comprises a piezoelectric actuator having a flexure-type linkage that provides mechanical amplification to extend the available range of motion for the associated radial engagement member 1510. Piezoelectric actuators with mechanical amplification are often referred to as “piezo flexure motors.” The extended motion, typically on the order of a few millimeters, facilitates the radial engagement member moving between unengaged and engaged positions to facilitate the optical storage medium 100 being loaded and unloaded from the stage 1520 prior to, and after, performance of write operations.

Each radial compression fixture 1505 imparts a radially-inward compressive force,-F_{C} 1530, from the perimeter of the optical storage medium 100 towards the center axis 1525. In some embodiments, a pressure transducer or sensor 1535 may be utilized with one or more of the radial engagement members to monitor the force being applied to the optical storage medium 100 during operation of the radial compression fixtures. The stage 1520, actuators 1515, sensors 1535, and write system (not shown) may be operatively coupled to, and controlled from, a control system 1540 during write operations in some implementations using appropriate communication interfaces and/or networks (not shown). In illustrative implementations, the control system may utilize signals representing the forces monitored by the sensors as inputs utilized for controlling various aspects of the write operations. For example, the control system is configurable to control write parameters for the laser (e.g., write speed, pulse energy, duration, repetition rate, or wavelength), motion of the stage (e.g., rotation and/or translation), and the radial and/or axial compressive forces applied by the fixtures. The control system can establish and dynamically maintain a desired application of compressive forces on the optical storage medium throughout the write processes if and when operating conditions change, for example, through normal variations in operations, or from sub-optimal operations of one or more components due to failures or other causes. For example, if the speed of rotation varies during write operations, the control system can send control signals to cause the fixtures to apply more or less force to the optical storage medium, as appropriate, to compensate for the varying inertially-induced stress in the medium. Similarly, if the write parameters change during the write operations, the control system can send control signals to cause the fixtures to apply more or less force to the optical storage medium, as appropriate, to compensate for the varying thermally-induced stress in the medium. Conversely, if the forces applied by the fixtures vary up or down, the control system can adjust the write parameters and/or stage motion to accommodate such force variations to ensure that the target maximum tensile stress in the optical storage medium is not exceeded.

FIG. 16 shows an illustrative arrangement of radial compression fixtures, representatively indicated by reference numeral 1605. Each comprises a radial engagement member 1610 and a hydraulic actuator 1615 that are coupled together by a push-pull type linkage 1620 (shown in greater detail in the enlarged view). As a push rod 1625 is extended from a hydraulic cylinder 1630 using hydraulic pressure from a pump (not shown) or other suitable source of hydraulic pressure, it exerts force on the linkage 1620 which operates through pivot points to pull the engagement member 1610 radially inwards to apply a compressive force to the optical storage medium (not shown for sake of clarity in exposition). In some embodiments, a pressure transducer or sensor (not shown) may be utilized with one or more of the engagement members to monitor the force being applied to the optical storage medium. In an alternative embodiment, moveable weights (not shown) are utilized to provide the actuator force instead of the hydraulic cylinder. As the stage 1635 rotates, the centrifugal force on the weights causes them to exert a force on the linkage 1620 which operates through pivot points to pull the engagement member 1610 radially inwards to apply a compressive force to the optical storage medium.

The radial compression fixtures 1605 are located inboard of the optical storage medium (not shown for sake of clarity in exposition) around its perimeter on the stage 1635 and rotate about the central axis 1640 of the stage along with the optical storage medium during write operations. Locating the majority of the mass of the radial compression fixtures inboard, and thus closer to the central axis, can reduce the centrifugal forces imparted to the fixtures. This may be beneficial in some implementations, for example, when the higher rotational speeds of the stage and optical storage medium are utilized during write operations. As with the arrangement shown in FIG. 15 and described above, a control system (not shown) may be operatively coupled to the sensors, stage, radial compression fixture, and write system (not shown) to control the various aspects of the write operations.

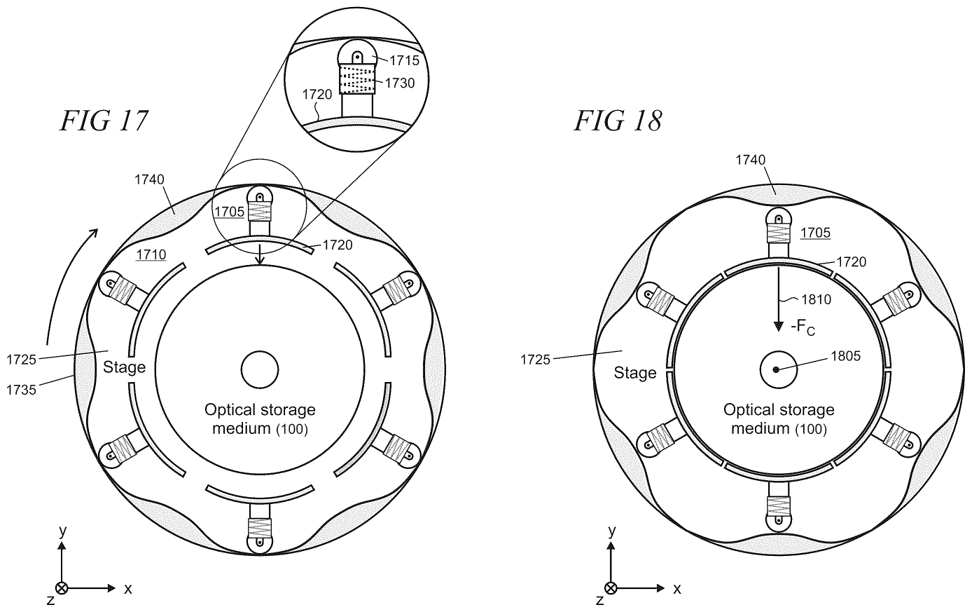

FIGS. 17 and 18 show an illustrative arrangement of radial compression fixtures, representatively indicated by reference numeral 1705, that utilize mechanical actuation comprising a roller and cam system 1710. As shown in the enlarged view in FIG. 17, each radial compression fixture comprises a roller 1715 that is coupled to a radial engagement member 1720. The roller and engagement member are configured to move along a radial path on the stage 1725. In this illustrative example, the roller and engagement member are coupled via a spring 1730 to ensure consistent contact force to the optical storage medium 100 when they are moved from an unengaged position shown in FIG. 17 to an engaged position shown in FIG. 18. As shown, a cam plate 1735 includes six identical cam lobes, as representatively indicated by reference numeral 1740.

As the cam plate 1735 is rotated relative to the stage 1725, the roller 1715 of each radial compression fixture 1705 travels against the surface of a respective cam lobe (e.g., cam lobe 1740) which causes radially-inward directed motion of the fixture towards the center of the optical storage medium 100. When in the engaged position, as shown in FIG. 18, the radial compression fixtures exert radially-inward directed compressive forces on the optical storage medium from the perimeter towards the central axis 1805. The compressive forces are representatively shown by a-F_{C} vector 1810. As with the arrangement shown in FIG. 15 and described above, a control system (not shown) may be operatively coupled to the sensors, stage, radial compression fixture, and write system (not shown) to control the various aspects of the write operations. 1805.

FIGS. 19, 20, and 21 show an illustrative example of a radially expanding mandrel 1905 that applies forces to the optical storage medium 100. The mandrel primarily functions as a locating spindle for the optical storage medium to interface with a receiving area on a stage 1910, as shown in FIG. 20. It is noted that the configuration of the stage including size and shape can vary from that which is depicted in the drawings. The particular stage configuration utilized for a given implementation of the present principles will typically be selected to provide suitable support for the optical storage medium while enabling rotation and operation of the various fixtures described herein during write operations. The mandrel includes a number of members, representatively indicated by reference numeral 1915, that are configured to elastically expand radially outwards through downward action of an axially-moving wedge 1920 against a bearing surface 1925 in the interior of the mandrel, as shown in the enlarged view in FIG. 20.

The forces induced from the mandrel 1905 in its expanded position include radial normal (i.e., compressive) forces against the walls of the through-hole in the glass substrate of the optical storage medium 100, as representatively indicated by the-F_{C} vector 2105 in FIG. 21. The radial forces further induce frictional forces at the mandrel-substrate interface at the walls, as representatively indicated by the F_{F} vector 2110. The frictional forces tend to constrain displacement of the optical storage medium from buckling from the radially-inward compressive forces applied by the radial compression fixtures, as discussed above (as the frictional forces oppose the direction of motion from the applied compressive forces, they are signed positively). However, as the mandrel 1905 is primarily used for centering the optical storage medium on the stage 1910, the forces imparted by the mandrel are purposefully small, in typical implementations, to avoid causing undue stress around the region of the through-hole.

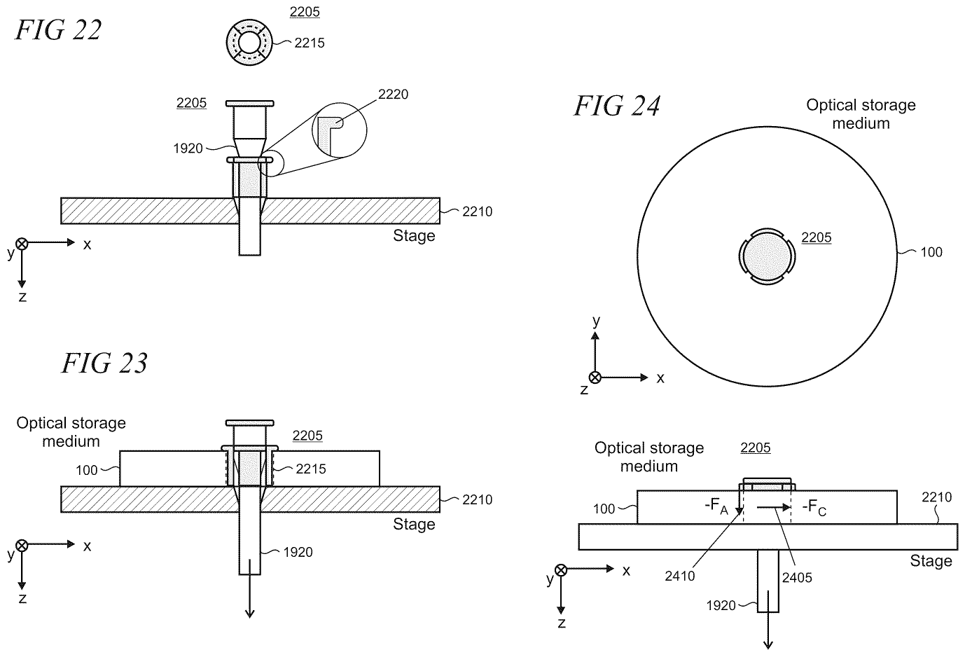

FIGS. 22, 23, and 24 show an illustrative example of a radially expanding mandrel 2205 that applies radial and axial forces to the optical storage medium 100. The mandrel functions as a locating spindle for the optical storage medium to interface with a receiving area on a stage 2210, as shown in FIG. 23. The mandrel includes a number of members, representatively indicated by reference numeral 2215, that are configured to elastically expand radially outwards through downward action of an axially-moving wedge 1920 against a race (not shown) in the interior of the mandrel. As shown in the enlarged view in FIG. 22, each member of the mandrel includes a lip 2220 that interfaces with a top surface of the optical storage medium near the central through-hole when the mandrel is in its expanded position.

As shown in FIG. 24, the mandrel members exert normal forces against the walls of the through-hole in the glass substrate of the optical storage medium 100, as representatively indicated by the-F_{C} vector 2405. The radial forces further induce frictional forces at the mandrel-substrate interface at the walls (not indicated in the drawing). The lip 2220 of the mandrel members apply axially directed forces downwards at the top surface of the optical storage medium near the central through-hole, as representatively indicated by the -F_{A} vector 2410. The frictional and axial forces applied near the central through-hole of the optical storage medium provide axial support for the medium to mitigate against buckling from the radially-inward compressive forces applied by the radial compression fixtures. It is noted that the axial forces directed on the top surface of the optical storage medium are the principal forces utilized to provide support for the medium on the stage. The radial forces applied to the walls of the central through-hole are typically sought to be minimized to avoid undue stress around the hole.

The use of radially-expanding mandrels, as illustratively shown in the embodiments described above, are configured to enable the optical storage medium to be positioned over the mandrels which function as locating members when in their unexpanded positions. Such configurations may facilitate placement of the optical storage medium on the rotating stage using automated processes such as those implemented using pick and place robotics, or other suitable automated machines. Each mandrel embodiment may include one or more pressure sensors which can be operatively coupled to a suitable control system. Each mandrel embodiment is further configurable to be controllable from the control system.

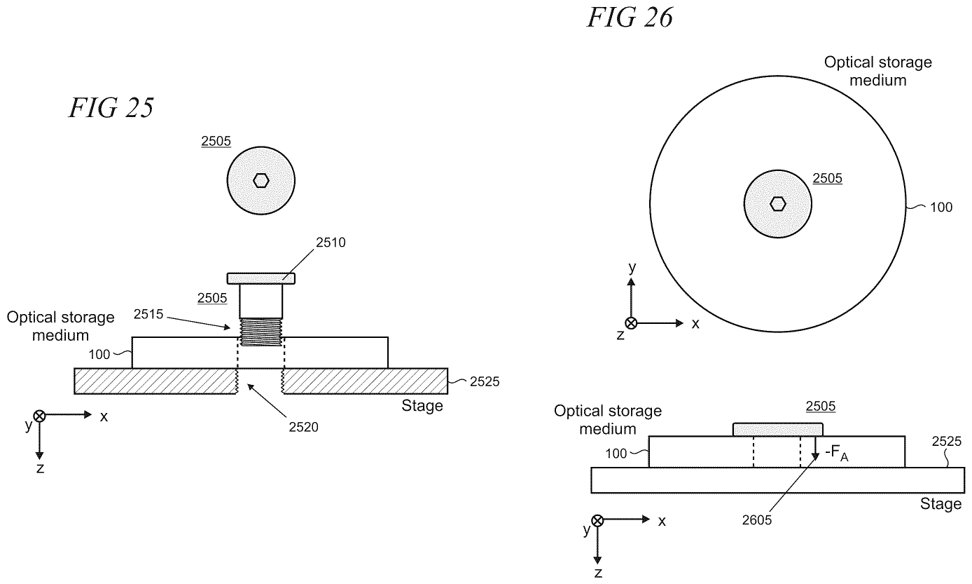

FIGS. 25 and 26 show an alternative to the radially-expanding mandrels that comprises a mechanical fastener 2505 having a head 2510 with a diameter that exceeds the diameter of the central through-hole in the optical storage medium 100. The exposed underside of the head provides a bearing surface that provides an axial compressive force around the central through-hole at a top surface of the optical storage medium when a threaded portion 2515 of the mechanical fastener is threadedly-engaged with a corresponding threaded receiving portion 2520 of the stage 2525. As shown, the top surface of the optical storage medium is opposite the bottom surface that contacts the stage.

As shown in FIG. 26, the head of the mechanical fastener 2505 applies axially directed forces downwards at the top surface of the optical storage medium near the central through-hole, as representatively indicated by the -F_{A} vector 2605 when the fastener is tightened. It may be appreciated that the mechanical fastener applies axial forces and does not provide radially-directed normal forces to the walls of the through-hole. It may be appreciated that some shear stress (not shown) may be induced at the interface between the fastener and the walls of the central through-hole from the rotation of the fastener is threadedly-engaged with the stage 2525.

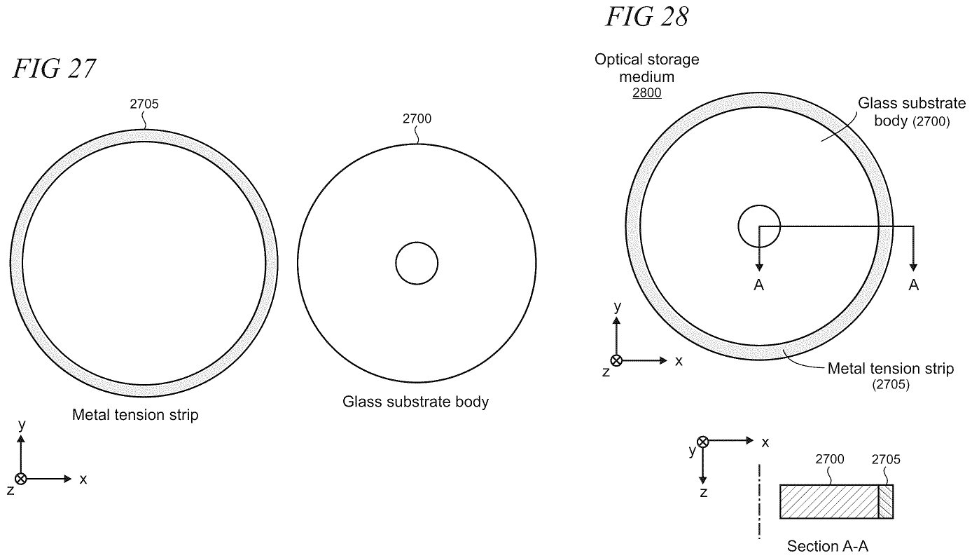

FIG. 27 shows a disassembled view of an illustrative embodiment of an optical storage medium 2800 for pre-stressing a glass substrate body 2700 of the optical storage medium in compression using an alternative technique to that provided by the radial compression fixtures, as discussed above. A metal tension strip 2705 has an inner diameter that is approximately the same as the outer diameter of the glass substrate body 2700 to enable production of an annular assembly 2800 comprising the metal tension strip and glass, as shown in FIG. 28. For the discussion that follows with regard to the use of the metal tension strip to pre-stress the glass, it may be understood that the term “optical storage medium” refers to the assembly 2800 of the glass and metal tension strip. The term “glass substrate body” refers to a disc-shaped volume of glass material that is used in the assembly (which may optionally include a central hole or aperture) but which does not include the metal tension strip 2705.

The metal tension strip 2705 is fabricated from a metal, metal alloy, metalloid, or similar material having suitable material properties including coefficient of thermal expansion and finish characteristics. For example, suitable metals may include stainless steels, cold-rolled steels (CRS), and other ferrous alloys (which may or may not be plated), nickel-based alloys such as Hastelloy®, nickel-copper alloys such as Monel®, and non-ferrous metals and alloys such as copper and aluminum. In some implementations, the metal tension strip is fabricated from coiled stock. The metal tension strip may be formed into a ring form factor prior to the assembly with the glass substrate body 2700, or during assembly with the glass. In alternative embodiments, the tension strip is formed using non-metallic materials, or from composite materials that include metallic and non-metallic components. Non-metallic materials which may be suitable in some applications include polymers, ceramics, and composites such as fiber-reinforced composites, and ceramic matrix composites. When selecting non-metallic materials for the tension strip, it may be appreciated that material properties including thermal expansion coefficient and elasticity are typically considered.

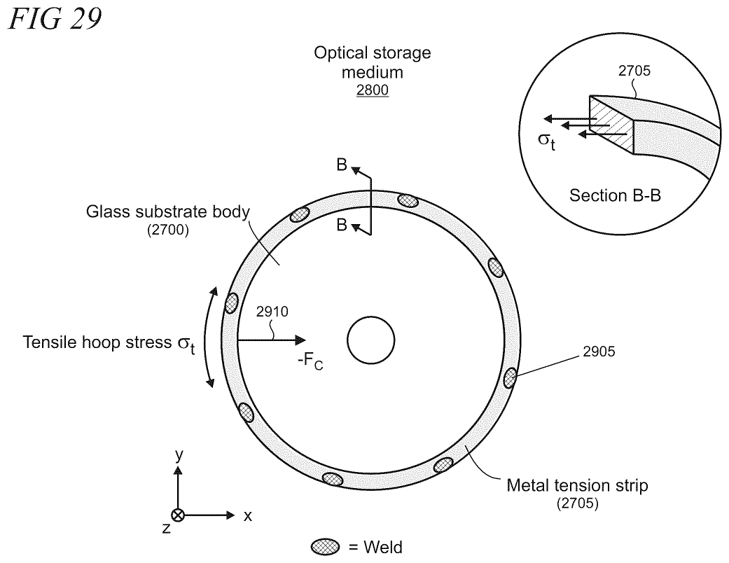

After assembling the optical storage medium 2800 from the metal tension strip 2705 and glass substrate body 2700, the metal tension strip is put into tension using heating and cooling to induce hoop stress, Ot, in the strip to thereby create a circumferential compression band encircling the annular peripheral edge portion of the glass substrate body. The tensile hoop stress provides a substantially uniform radially-inward compressive stress throughout the glass substrate body from the edge towards the central through-hole, as representatively indicated by the -F_{C} vector 2910 shown in FIG. 29. However the compressive stress profile in the glass substrate body has a directional dependency and thus has lower overall uniformity compared to stress profile in the glass when subjected to the pressurized write environment discussed above with reference to FIG. 10. In alternative embodiments, rather than inducing hoop stress in the strip using heating and cooling, tensile stress may be imparted using mechanical devices or systems such as inserts to directly induce inward forces on the glass substrate body. Other methods may utilize, for example, material manipulation techniques such that residual stresses are introduced during manufacturing processes such as filament winding of composite materials.

FIG. 29 shows use of an illustrative welding technique that is utilized to induce hoop stress, Ot, in the metal tension strip 2705. A number of welds (representatively indicated by reference numeral 2905) are made around the perimeter of the metal tension strip towards the outside surface to reduce or avoid uneven forces being applied to the edge of the glass substrate body 2700. For example, the welds may be implemented using a laser welding system or other suitable system. Because of differing thermal expansion coefficients of metal and glass during a cooling process under ambient conditions after welding, a compressive stress condition is created in the glass substrate body 2700, proportional to the normal unconfined expansion at the welding temperature.

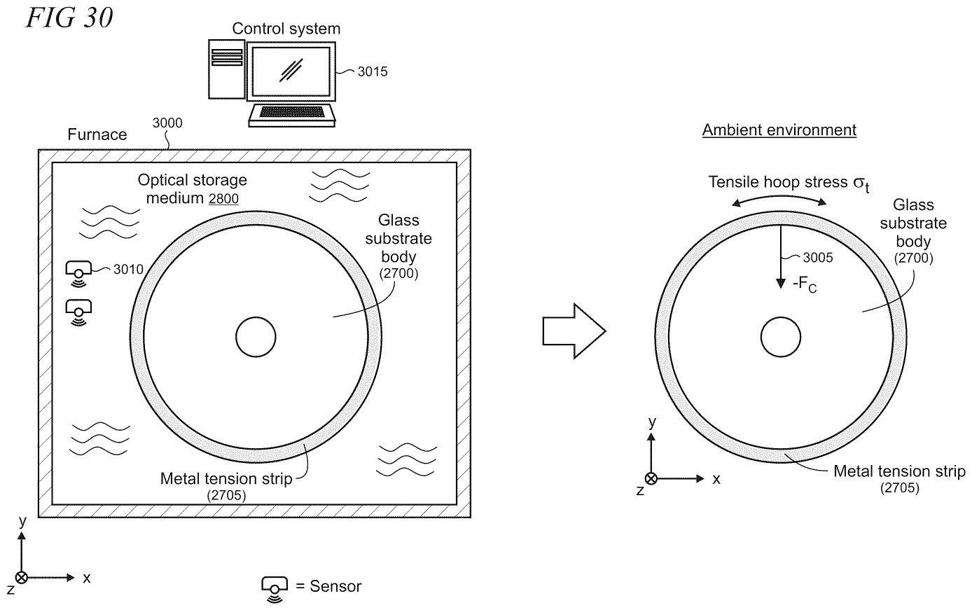

Hoop stress may be induced in the metal tension strip 2705 using a furnace 3000, as shown in FIG. 30. The optical storage medium 2800 assembled from the glass substrate body 2700 and metal tension strip 2705 are heated in the furnace until a fusing temperature is reached at which the glass moves towards the metal tension strip. During a cooling process under ambient conditions after fusion, a compressive stress condition is created in the glass substrate body proportional to the normal unconfined expansion at the fusion temperature. The tensile hoop stress induced by the heating and cooling in the metal tension strip provides a substantially uniform radially-inward compressive stress throughout the glass substrate body from the edge towards the central through-hole, as representatively indicated by the-F_{C} vector 3005. Beneficially, the radially-inward compressive stress then remains, even at ambient temperatures. As with the previous embodiment, the compressive stress profile in the glass substrate body has a directional dependency.

One or more sensors 3010, such as temperature sensors, are typically located within the furnace 3000. The sensors and heating elements (not shown) in the furnace are coupled to a control system 3015 via appropriate communication interfaces and/or networks (not shown) to provide for centralized control over heating and/or cooling of the optical storage medium 2800 used to induce the hoop stress in the metal tension strip 2705 and pre-stress the glass substrate body 2700 in compression in accordance with the present principles.

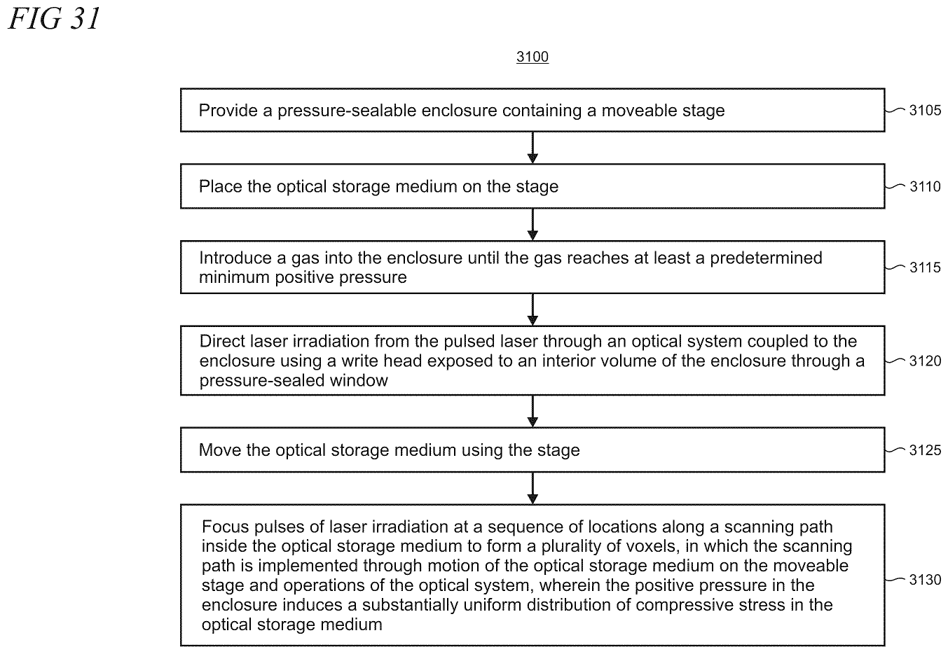

FIG. 31 is a flowchart of an illustrative method 3100 for writing data to an optical storage medium under positive pressure using a laser-based writing system having a laser that operates by producing pulses of irradiation in accordance with the present principles. Unless specifically stated, the methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

Block 3105 includes providing a pressure-sealable enclosure containing a moveable stage. Block 3110 includes placing the optical storage medium on the stage. Block 3115 includes introducing a gas into the enclosure until the gas reaches at least a predetermined (minimum) positive pressure. It may be appreciated that positive pressures exceeding the predetermined minimum level may be advantageously utilized, in some embodiments. The higher pressures can further counteract, either fully or partially, thermally-induced and inertially-induced stress. This may enable increases in write speed and/or optical storage medium rotation speed (in implementations in which a rotating stage and disc-shaped medium are utilized) without exceeding the target maximum tensile stress in the medium. Conversely, if only a level of positive pressure below the predetermined minimum is realizable for some reason (e.g., during equipment initialization and startup), the write speed and/or rotation speed of the optical storage medium can be reduced until the predetermined minimum positive pressure is reached.

Block 3120 includes directing laser irradiation from the pulsed laser through an optical system coupled to the enclosure using a write head exposed to an interior volume of the enclosure through a pressure-sealed window. Block 3125 includes moving the optical storage medium using the stage.

Block 3130 includes focusing pulses of laser irradiation at a sequence of locations along a scanning path inside the optical storage medium to form a plurality of voxels, in which the scanning path is implemented through motion of the optical storage medium on the moveable stage and operations of the optical system, wherein the positive pressure in the enclosure induces a substantially uniform distribution of compressive stress in the optical storage medium.

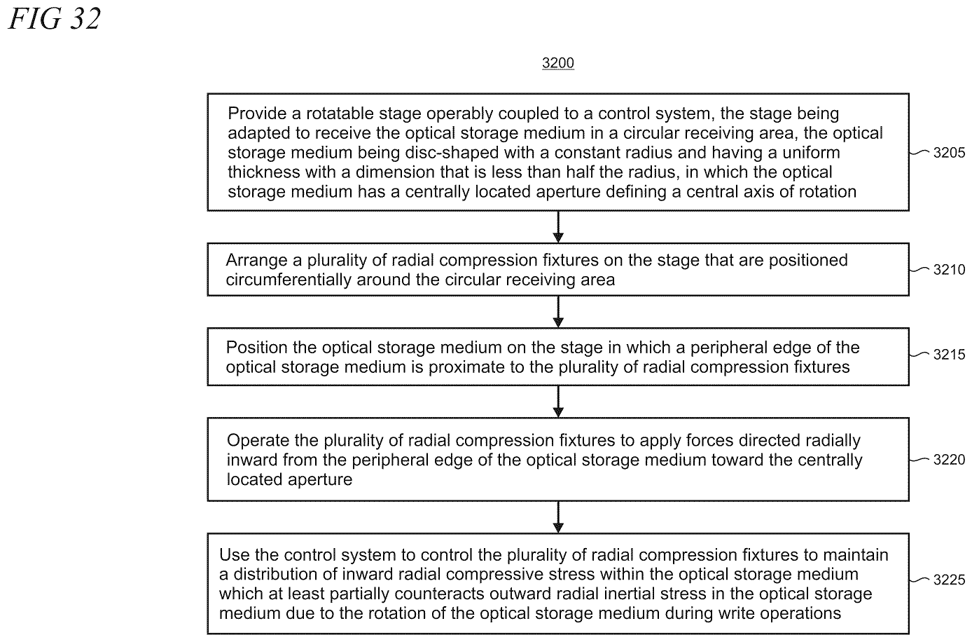

FIG. 32 is a flowchart of an illustrative method 3200 to pre-stress an optical storage medium subject to write operations for data storage using a laser-based writing system having a laser that operates by producing pulses of irradiation directed at the optical storage medium as the optical storage medium is rotated.

Block 3205 includes providing a rotatable stage operably coupled to a control system, the stage being adapted to receive the optical storage medium in a circular receiving area, the optical storage medium being disc-shaped with a constant radius and having a uniform thickness with a dimension that is less than half the radius, in which the optical storage medium has a centrally located aperture defining a central axis of rotation. Block 3210 includes arranging a plurality of radial compression fixtures on the stage that are positioned circumferentially around the circular receiving area.

Block 3215 includes positioning the optical storage medium on the stage in which a peripheral edge of the optical storage medium is proximate to the plurality of radial compression fixtures. Block 3220 includes operating the plurality of radial compression fixtures to apply forces directed radially inward from the peripheral edge of the optical storage medium toward the centrally located aperture.

Block 3225 includes using the control system to control the plurality of radial compression fixtures to maintain a distribution of inward radial compressive stress within the optical storage medium which at least partially counteracts outward radial inertial stress in the optical storage medium due to the rotation of the optical storage medium during write operations. It may be appreciated that the distribution of stress may be advantageously imparted to the optical storage medium at a level that is higher than a predetermined minimum level, in some embodiments. The higher level of stress induced in the optical storage medium by application of forces from the radial compression fixtures can further counteract, either fully or partially, thermally-induced and inertially-induced stress. Such increased stress may enable increases in write speed and/or optical storage medium rotation speed without exceeding the target maximum tensile stress in the optical storage medium. Conversely, if only a stress distribution below the predetermined minimum is realizable for some reason (e.g., during equipment initialization and startup), the write speed and/or rotation speed of the optical storage medium can be reduced until the predetermined minimum stress distribution within is reached.

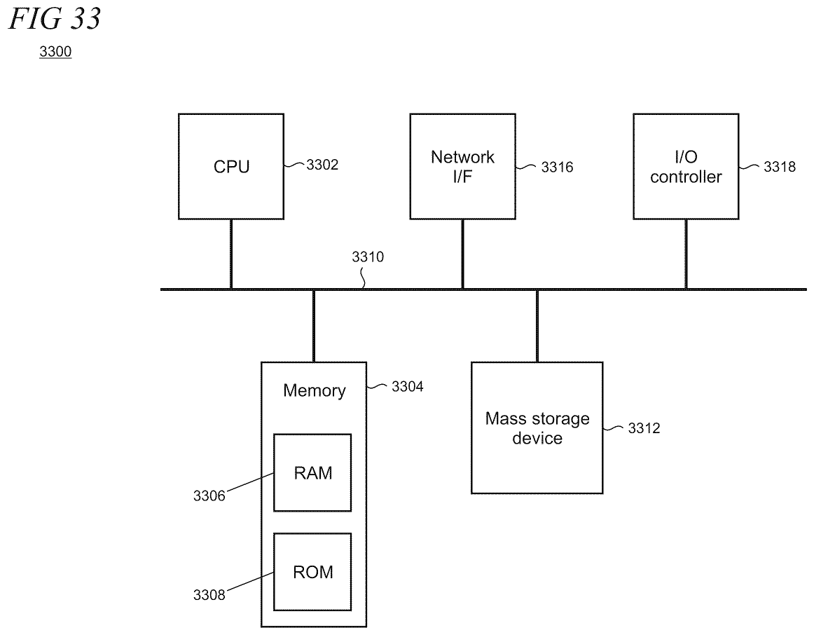

FIG. 33 shows an illustrative architecture 3300 for a computing device, such as a server, capable of executing the various components described herein. The architecture 3300 illustrated in FIG. 33 includes one or more processors 3302 (e.g., central processing unit, dedicated AI (artificial intelligence) chip, graphics processing unit, etc.), a system memory 3304, including RAM (random access memory) 3306 and ROM (read only memory) 3308, and a system bus 3310 that operatively and functionally couples the components in the architecture 3300. A basic input/output system containing the basic routines that help to transfer information between elements within the architecture 3300, such as during startup, is typically stored in the ROM 3308. The architecture 3300 further includes a mass storage device 3312 for storing software code or other computer-executed code that is utilized to implement applications, a file system, and an operating system (OS). The mass storage device 3312 is connected to the processor 3302 through a mass storage controller (not shown) connected to the bus 3310. The mass storage device 3312 and its associated computer-readable storage media provide non-volatile storage for the architecture 3300. Although the description of computer-readable storage media contained herein refers to a mass storage device, such as an HDD (hard disk drive) or CD (compact disc) drive, it may be appreciated by those skilled in the art that computer-readable storage media can be any available storage media that can be accessed by the architecture 3300.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray or other optical storage, magnetic cassettes, magnetic tape, magnetic disk storage or other magnetic storage devices, or any other medium which can be used to store the desired information and which can be accessed by the architecture 3300.

According to various embodiments, the architecture 3300 may operate in a networked environment using logical connections to remote computers through a network. The architecture 3300 may connect to the network through a network interface unit 3316 connected to the bus 3310. It may be appreciated that the network interface unit 3316 also may be utilized to connect to other types of networks and remote computer systems. The architecture 3300 also may include an input/output controller 3318 for receiving and processing input from a number of other devices, including a keyboard, mouse, touchpad, touchscreen, and control devices such as buttons and switches or electronic stylus (not shown in FIG. 33). Similarly, the input/output controller 3318 may provide output to a display screen, user interface, a printer, or other type of output device (also not shown in FIG. 33).

It may be appreciated that the software components described herein may, when loaded into the processor 3302 and executed, transform the processor 3302 and the overall architecture 3300 from a general-purpose computing system into a special-purpose computing system customized to facilitate the functionality presented herein. The processor 3302 may be constructed from any number of transistors or other discrete circuit elements, which may individually or collectively assume any number of states. More specifically, the processor 3302 may operate as a finite-state machine, in response to executable instructions contained within the software modules disclosed herein. These computer-executable instructions may transform the processor 3302 by specifying how the processor 3302 transitions between states, thereby transforming the transistors or other discrete hardware elements constituting the processor 3302.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 3300 in order to store and execute the software components presented herein. It also may be appreciated that the architecture 3300 may include other types of computing devices, including wearable devices, handheld computers, embedded computer systems, smartphones, PDAs (personal digital assistants), and other types of computing devices known to those skilled in the art. It is also contemplated that the architecture 3300 may not include all of the components shown in FIG. 33, may include other components that are not explicitly shown in FIG. 33, or may utilize an architecture completely different from that shown in FIG. 33.

Various exemplary embodiments of the present increasing write speed of optical data by pre-stressing glass storage media are now presented by way of illustration and not as an exhaustive list of all embodiments. An example includes an optical storage medium arranged for embedding a plurality of voxels to store data, wherein data is written to the optical storage medium using a writing system having a laser that operates by producing pulses of irradiation while the optical storage medium rotates about a central axis during operations of the laser producing pulses of irradiation, the optical storage medium comprising: a disc-shaped body made of an optically transparent substrate to allow transmission of laser irradiation to interior locations within the body, the body comprising a planar central portion and an annular peripheral edge portion, wherein a thickness of the body is smaller relative to a radius of the planar central portion; and a tension strip, pre-stressed in tension and encircling the annular peripheral edge portion of the body as a circumferential compression band, providing substantially uniform radially-inward compressive stress throughout the body, wherein the compressive stress counteracts radial inertial stress in the body due to rotation of the optical storage medium.

In another example, the tension strip comprises metal and is pre-stressed in tension by heat through application of welding at a plurality of locations on one or both opposing sides of the metal tension strip followed by cooling to ambient temperature to induce tensile hoop stress in the metal tension strip. In another example, the welding is performed at one or more locations around a perimeter of the metal tension strip to reduce application of uneven forces at edges of the body. In another example, the metal tension strip is pre-stressed in tension by application of heat in a temperature-controlled furnace followed by cooling to ambient temperature to induce tensile hoop stress in the metal tension strip. In another example, the voxels are one of phase voxel or birefringent voxel and are arranged in a plurality of layers in the optical storage medium. In another example, the optically transparent substrate comprises one of borosilicate glass, fused-silica glass, soda-lime glass, or alumino-silicate glass. In another example, the optically transparent substrate comprises a through-hole centrally located within the planar central portion, the through-hole being aligned with the central axis.

A further example includes a method for writing data to an optical storage medium under positive pressure using a laser-based writing system having a laser that operates by producing pulses of irradiation, comprising: providing a pressure-sealable enclosure containing a moveable stage; placing the optical storage medium on the stage; introducing a gas into the enclosure until the gas reaches at least a predetermined minimum positive pressure; in write operations, directing laser irradiation from the pulsed laser through an optical system coupled to the enclosure using a write head exposed to an interior volume of the enclosure through a pressure-sealed window; moving the optical storage medium using the stage; and focusing pulses of laser irradiation at a sequence of locations along a scanning path inside the optical storage medium to form a plurality of voxels, in which the scanning path is implemented through motion of the optical storage medium on the moveable stage and operations of the optical system, wherein the positive pressure in the enclosure induces a substantially uniform distribution of compressive stress in the optical storage medium to pre-stress the optical storage medium against tensile stress induced during the write operations.

In another example, the method further comprises providing and maintaining pressure of the gas at the predetermined positive pressure using one or more pumps and one or more valves that are operably controlled by a control system. In another example, the optical system comprises one or more of beam steering optics or focusing optics and operations of the optical system comprise focusing a point of focus of the pulsed laser at different locations within the interior volume of the optical storage medium by one or more of beam steering the irradiation of the pulsed laser, adjusting a focal depth of the irradiation of the pulsed laser, or moving the optical storage medium with respect to the write head. In another example, the optical system further includes beam splitting optics. In another example, the optical storage medium is disc shaped and has a central axis, the optical storage medium being configured with a central through-hole that provides alignment of the optical storage medium with the stage, or the optical storage medium being configured without a central through-hole, and further comprising configuring the stage to impart rotation to the optical storage medium about the central axis and in which the compressive stress in the optical storage medium at least partially counteracts radial inertial stress in the optical storage medium due to the rotation of the optical storage medium imparted by the stage. In another example, the stage and laser-based writing system are operatively coupled to a control system and the method further comprises monitoring pressure in the enclosure using a sensor and synchronizing the rotation by the stage with the operations of the pulsed laser and optical system using the control system based on a signal from the sensor. In another example, the compressive stress in the optical storage medium has a magnitude that at least partially counteracts thermal stress in the optical storage medium arising during voxel formation in the optical storage medium from irradiation via operations of the pulsed laser.

A further example includes a method to pre-stress an optical storage medium subject to write operations for data storage using a laser-based writing system having a laser that operates by producing pulses of irradiation directed at the optical storage medium as the optical storage medium is rotated, comprising: providing a rotatable stage operably coupled to a control system, the stage being adapted to receive the optical storage medium in a circular receiving area, the optical storage medium being disc-shaped with a constant radius and having a uniform thickness with a dimension that is less than half the radius, in which the optical storage medium has a centrally located aperture defining a central axis of rotation; arranging a plurality of radial compression fixtures on the stage that are positioned circumferentially around the circular receiving area; positioning the optical storage medium on the stage in which a peripheral edge of the optical storage medium is proximate to the plurality of radial compression fixtures; operating the plurality of radial compression fixtures to apply forces directed radially inward from the peripheral edge of the optical storage medium toward the centrally located aperture; and using the control system to control the plurality of radial compression fixtures to maintain a distribution of inward radial compressive stress within the optical storage medium which at least partially counteracts outward radial inertial stress in the optical storage medium due to the rotation of the optical storage medium during write operations.

In another example, one or more of the radial compression fixtures comprise an engagement member configured to bear against the peripheral edge of the optical storage medium and an actuator that provides mechanical force. In another example, the engagement member is coupled to the actuator by a linkage. In another example, the actuator comprises one of piezoelectric actuator, hydraulic actuator, pneumatic actuator, magnetic actuator, electric actuator, electromechanical actuator, mechanical actuator, moveable weight, or shape memory alloy (SMA) actuator. In another example, the method further comprises arranging one or more axial compression fixtures to apply a supporting compressive force around the centrally located aperture of the optical storage medium to mitigate against buckling of the optical storage medium induced by the radially inward directed forces from the radial compression fixtures. In another example, the one or more axial compression fixtures comprise a radially-expandable mandrel operating along the central axis, the mandrel having an unexpanded position and an expanded position, the mandrel contacting inner walls of the aperture when the mandrel is in the expanded position, or the mandrel contacting a portion of a top surface of the optical storage medium, the top surface being opposite a bottom surface of the optical storage medium that contacts the stage, when the mandrel is in the expanded position.

Although the subject matter has been described in language specific to structural features and/or methodological acts, it is to be understood that the subject matter defined in the appended claims is not necessarily limited to the specific features, components, elements, and/or acts described above. Rather, the specific features, components, elements, and/or acts described above are disclosed as exemplary forms of implementing the claims, but are not necessarily the sole forms of implementing the claims.

What is claimed:

1. An optical storage medium arranged for embedding a plurality of voxels to store data, wherein data is written to the optical storage medium using a writing system having a laser that operates by producing pulses of irradiation while the optical storage medium rotates about a central axis during operations of the laser producing pulses of irradiation, the optical storage medium comprising:
a disc-shaped body made of an optically transparent substrate to allow transmission of laser irradiation to interior locations within the body, the body comprising a planar central portion and an annular peripheral edge portion, wherein a thickness of the body is smaller relative to a radius of the planar central portion; and
a tension strip, pre-stressed in tension and encircling the annular peripheral edge portion of the body as a circumferential compression band, providing substantially uniform radially-inward compressive stress throughout the body, wherein the compressive stress counteracts radial inertial stress in the body due to rotation of the optical storage medium.

2. The optical storage medium of claim 1, in which the tension strip comprises metal and is pre-stressed in tension by heat through application of welding at a plurality of locations on one or both opposing sides of the metal tension strip followed by cooling to ambient temperature to induce tensile hoop stress in the metal tension strip.

3. The optical storage medium of claim 2, in which the welding is performed at one or more locations of the metal tension strip around a perimeter of the metal tension strip to reduce application of uneven forces at edges of the body.

4. The optical storage medium of claim 1, in which the metal tension strip is pre-stressed in tension by application of heat in a temperature-controlled furnace followed by cooling to ambient temperature to induce tensile hoop stress in the metal tension strip.

5. The optical storage medium of claim 1, in which the voxels are one of phase voxel or birefringent voxel and in which the voxels are arranged in a plurality of layers in the optical storage medium.

6. The optical storage medium of claim 1, in which the optically transparent substrate comprises one of borosilicate glass, fused-silica glass, soda-lime glass, or alumino-silicate glass.

7. The optical storage medium of claim 1, in which the optically transparent substrate comprises a through-hole centrally located within the planar central portion, the through-hole being aligned with the central axis.

8. A method for writing data to an optical storage medium under positive pressure using a laser-based writing system having a laser that operates by producing pulses of irradiation, comprising:
providing a pressure-sealable enclosure containing a moveable stage;
placing the optical storage medium on the stage;
introducing a gas into the enclosure until the gas reaches at least a predetermined minimum positive pressure;
in write operations, directing laser irradiation from the pulsed laser through an optical system coupled to the enclosure using a write head exposed to an interior volume of the enclosure through a pressure-sealed window;
moving the optical storage medium using the stage; and
focusing pulses of laser irradiation at a sequence of locations along a scanning path inside the optical storage medium to form a plurality of voxels, in which the scanning path is implemented through motion of the optical storage medium on the moveable stage and operations of the optical system,
wherein the positive pressure in the enclosure induces a substantially uniform distribution of compressive stress in the optical storage medium to pre-stress the optical storage medium against tensile stress induced during the write operations.

9. The method of claim 8 further comprising providing and maintaining pressure of the gas at the predetermined positive pressure using one or more pumps and one or more valves that are operably controlled by a control system.

10. The method of claim 8, in which the optical system comprises one or more of beam steering optics or focusing optics and in which operations of the optical system comprise focusing a point of focus of the pulsed laser at different locations within the interior volume of the optical storage medium by one or more of beam steering the irradiation of the pulsed laser, adjusting a focal depth of the irradiation of the pulsed laser, or moving the optical storage medium with respect to the write head.

11. The method of claim 8, in which the optical system further includes beam splitting optics.

12. The method of claim 8, in which the optical storage medium is disc shaped and having a central axis, the optical storage medium being configured with a central through-hole that provides alignment of the optical storage medium with the stage, or the optical storage medium being configured without a central through-hole, and further comprising configuring the stage to impart rotation to the optical storage medium about the central axis and in which the compressive stress in the optical storage medium at least partially counteracts radial inertial stress in the optical storage medium due to the rotation of the optical storage medium imparted by the stage.

13. The method of claim 12, in which the stage and laser-based writing system are operatively coupled to a control system and in which the method further comprises monitoring pressure in the enclosure using a sensor and synchronizing the rotation by the stage with the operations of the pulsed laser and optical system using the control system based on a signal from the sensor.

14. The method of claim 8, in which the compressive stress in the optical storage medium has a magnitude that at least partially counteracts thermal stress in the optical storage medium arising during voxel formation in the optical storage medium from irradiation via operations of the pulsed laser.

15. A method to pre-stress an optical storage medium subject to write operations for data storage using a laser-based writing system having a laser that operates by producing pulses of irradiation directed at the optical storage medium as the optical storage medium is rotated, comprising:
providing a rotatable stage operably coupled to a control system, the stage being adapted to receive the optical storage medium in a circular receiving area, the optical storage medium being disc-shaped with a constant radius and having a uniform thickness with a dimension that is less than half the radius, in which the optical storage medium has a centrally located aperture defining a central axis of rotation;
arranging a plurality of radial compression fixtures on the stage that are positioned circumferentially around the circular receiving area;
positioning the optical storage medium on the stage in which a peripheral edge of the optical storage medium is proximate to the plurality of radial compression fixtures;
operating the plurality of radial compression fixtures to apply forces directed radially inward from the peripheral edge of the optical storage medium toward the centrally located aperture; and
using the control system to control the plurality of radial compression fixtures to maintain a distribution of inward radial compressive stress within the optical storage medium which at least partially counteracts outward radial inertial stress in the optical storage medium due to the rotation of the optical storage medium during write operations.

16. The method of claim 15, in which one or more of the radial compression fixtures comprise an engagement member configured to bear against the peripheral edge of the optical storage medium and an actuator that provides mechanical force.

17. The method of claim 16, in which the engagement member is coupled to the actuator by a linkage.

18. The method of claim 16, in which the actuator comprises one of piezoelectric actuator, hydraulic actuator, pneumatic actuator, magnetic actuator, electric actuator, electromechanical actuator, mechanical actuator, moveable weight, or shape memory alloy (SMA) actuator.

19. The method of claim 16 further comprising arranging one or more axial compression fixtures to apply a supporting compressive force around the centrally located aperture of the optical storage medium to mitigate against buckling of the optical storage medium induced by the radially inward directed forces from the radial compression fixtures.

20. The method of claim 19, in which the one or more axial compression fixtures comprise a radially-expandable mandrel operating along the central axis, the mandrel having an unexpanded position and an expanded position, the mandrel contacting inner walls of the aperture when the mandrel is in the expanded position, or the mandrel contacting a portion of a top surface of the optical storage medium, the top surface being opposite a bottom surface of the optical storage medium that contacts the stage, when the mandrel is in the expanded position.
